(19) United States
(12) Patent Application Publication
(10) Pub. No.: US 2026/0254341 A1
(43) Pub. Date: Aug. 27, 2026

(54) MULTI-MODE POWER CONVERTERS WITH SHARED COMPONENTS

(71) Applicant: Murata Manufacturing Co., Ltd., Kyoto (JP)

(72) Inventors: David M. Giuliano, Bedford, NH (US); Gregory Szczeszynski, Nashua, NH (US)

(21) Appl. No.: 19/102,362

(22) PCT Filed: Jul. 14, 2023
(86) PCT No.: PCT/US2023/070224

§ 371 Date: Feb. 7, 2025

Related U.S. Application Data
(60) Provisional application No. 63/395,582, filed on Aug. 5, 2022.
(60) Provisional application No. 63/435,119, filed on Dec. 23, 2022.

(51) Int. Cl. H02M 1/00; H02J 7/00; H02J 7/80; H02J 7/90; H02M 1/14

(52) U.S. Cl. CPC H02M 1/0067; H02J 7/80; H02J 7/855; H02J 7/977; H02M 1/0043; H02M 1/14; H02J 2207/20

(57) ABSTRACT

Battery management circuits implementable with fewer components compared to conventional designs while maintaining performance. Embodiments encompass power converters including an adiabatic charge pump circuit coupled to a battery interface circuit through a first inductor, and an inductive buck converter circuit coupled to the battery interface circuit through a second inductor. In a first mode of operation, the adiabatic charge pump circuit is deactivated, and the inductive buck converter circuit is activated. In a second mode of operation, the adiabatic charge pump circuit is activated, and the inductive buck converter circuit is deactivated. The adiabatic charge pump circuit and the inductive buck converter circuit share a battery interface circuit and at least one of (1) power switches coupled to a voltage source terminal and a reference potential terminal, (2) at least one fly capacitor, or (3) the first inductor.

### CROSS REFERENCE TO RELATED APPLICATIONS

The present application claims priority to U.S. Provisional Application No. 63/395,582 filed on Aug. 5, 2022 and U.S. Provisional Application No. 63/435,119 filed on Dec. 23, 2022, the contents of both of which are incorporated herein by reference in their entireties.

### FIELD

This invention relates to electronic circuits, and more particularly to power converter circuits, including DC-DC power converter circuits, and battery management systems.

### BACKGROUND

Many electronic products, particularly mobile computing and/or communication products and components (e.g., cell phones, notebook computers, ultra-book computers, tablet devices, LCD and LED displays) require multiple voltage levels. For example, radio frequency (RF) transmitter power amplifiers may require relatively high voltages (e.g., 12V or more), whereas logic circuitry may require a low voltage level (e.g., 1-3V). Still other circuitry may require an intermediate voltage level (e.g., 5-10V).

Direct current (DC) power converters are often used to generate a lower or higher voltage from a common power source, such as a battery, solar cells, and rectified alternating current (AC) sources. Power converters which generate a lower output voltage level from a higher input voltage power source are commonly known as buck converters, so-called because the output voltage V_{OUT} is less than the input voltage V_{IN}, and hence the converter is “bucking” the input voltage. Power converters which generate a higher output voltage level from a lower input voltage power source are commonly known as boost converters, because V_{OUT} is greater than V_{IN}. Some power converters may be either a buck converter or a boost converter depending on a particular configuration, such as which terminals are used for input and output. Some power converters may provide an inverted output.

Modern devices, particularly mobile devices (e.g., cell phones), often require a sophisticated battery management system to optimize device usage time and battery life while protecting against battery overcharging and thermal degradation. It is known to utilize two different types of power converters in such battery management systems to charge the device battery and to provide a system voltage for the device.

One type of direct current power converter known as an inductive power converter may include charge transfer capacitors and a relatively large output inductor as energy storage elements coupled by controlled switches so as to transfer charge from V_{IN} to V_{OUT}. In some embodiments, an inductive power converter may be implemented as a multi-level inductive power converter. Another type of direct current power converter known as an adiabatic charge pump includes charge transfer capacitors and a relatively small output inductor as energy storage elements coupled by controlled switches so as to transfer charge from V_{IN} to V_{OUT}. In both types, the charge transfer capacitors are commonly known as “fly capacitors” or “pump capacitors”. Every time a fly capacitor is used (i.e., not bypassed), the electrical energy flowing through that fly capacitor generally will either charge it or discharge it. While multi-level power converters and adiabatic charge pumps may have similar topologies in some configurations, they differ in the magnitude of inductance needed for optimal performance and efficiency.

FIG. 1A is a schematic diagram of one example of a prior art adiabatic two-phase 3-Level charge pump 100. A first phase subcircuit comprises switches S1, S2 coupled in series between an input terminal for an input voltage V_{IN} and a node L_{X} between switches S2 and S3, shunt switches S3, S4 coupled in series between the node L_{X} and a reference potential (e.g., circuit ground), a fly capacitor C1 connected between switch pairs S1-S2 and S3-S4 as shown, and a relatively small (e.g., about 1 nH to several 100's of nH, depending on the power level) shared inductor LS (“S” is for “small”) coupled between the node L_{X} and an output terminal for V_{OUT}. A second phase subcircuit comprises switches S1′, S2′ coupled in series between the input terminal for V_{IN} and the node L_{X} between switches S2′ and S3′, shunt switches S3′, S4′ coupled in series between the node L_{X} and the reference potential, a fly capacitor C1′ connected between switch pairs S1′-S2′ and S3′-S4′ as shown, and the shared inductor LS coupled between the node L_{X} and the output terminal for V_{OUT}. A smoothing capacitor C0 is coupled between the output terminal and the reference potential. In operation, switches S1 and S3 are toggled in unison to the same OPEN or CLOSED state by a clock signal φ1, while switches S2 and S4 are toggled in unison to the same OPEN or CLOSED state by a clock signal φ2 that is phase interleaved (with a deadtime between phases) with respect to the clock signal φ1 (with deadtime between clock transitions). The result for the illustrated example is that V_{OUT}=½V_{IN}. Operation of switches S1′-S4′ is similar, but switches S1′ and S3′ are toggled in unison to the same OPEN or CLOSED state by the clock signal φ2, while switches S2′ and S4′ are toggled in unison to the same OPEN or CLOSED state by the clock signal φ1. Using two interleaved phases helps provide a smoother voltage and current at the output terminal.

FIG. 1B is a schematic diagram of one example of a prior art 3-Level inductive buck converter 102. A set of four switches, S1-S4, is series-coupled between an input terminal for V_{IN} and circuit ground. A fly capacitor C1 is coupled in series with switches S1 and S4, and in parallel with switches S2 and S3. A relatively large inductor L_{B} (“B” is for “big”) is coupled to an output capacitor C0 and to a node L_{X} between switches S2 and S3. Inductor L_{B} would typically have an inductance about 2 times to more than about 100 times the inductance of inductor L_{S}. The voltage across the output capacitor C0 is available at an output terminal as V_{OUT}.

In the illustrated example, the presence of the single fly capacitor C1 enables four switch states that each generate one of three voltage levels at node L_{X}: 0V (GND), V_{IN}, or V_{IN}/2 (in two different ways). In a first switch state defining a Level-1 voltage level at the L_{X} node, switches S3 and S4 are closed and switches S1 and S2 are opened, effectively bypassing C1 and connecting L_{X} to circuit ground (voltage level at L_{X}=GND). In a second switch state defining a Level-3 voltage level at the L_{X} node, switches S3 and S4 are opened and switches S1 and S2 are closed, again effectively bypassing C1 and connecting L_{X} to V_{IN} (voltage level at L_{X}=V_{IN}).

In a third switch state defining a Level-2 voltage level at the L_{X} node, switches S2 and S4 are opened and switches S1 and S3 are closed, connecting C1 from V_{IN} to L_{X}, and thus charging C1 with inductor L_{S} current flowing into a load. The voltage across C1 will be about V_{IN}/2 and the voltage level at L_{X} will also equal about V_{IN}/2. In a fourth switch state also defining the Level-2 voltage level at the L_{X} node, switches S2 and S4 are closed and switches S1 and S3 are opened, connecting C1 from L_{X} to GND and thus discharging C1 with inductor L_{S} current flowing from a load. The voltage across C1 will be about V_{IN}/2 and the voltage level at L_{X} will also equal about V_{IN}/2 (this assumes that C1 was previously charged in state three). Accordingly, the illustrated inductive buck converter 102 has two switch states that generate a Level-2 voltage level of V_{IN}/2 at the L_{X} node. By switching between levels using pulse-width modulation (PWM) control signals from a controller (not shown), a range of output voltages V_{OUT} can be achieved.

While a number of different architectures for battery management systems have been proposed or implemented, there is a need for circuits and methods for more effectively and efficiently providing battery management. In particular, there is a need for battery management circuit configurations that can be implemented with fewer components (thus reducing size) while maintaining circuit performance. The present invention addresses this and other needs.

### SUMMARY

The present invention encompasses battery management circuit configurations that can be implemented with fewer components compared to conventional designs (thus reducing IC size) while maintaining circuit performance.

In general, the present invention encompasses a power converter circuit including a first terminal for receiving a first voltage, a second terminal for providing a second voltage, a third terminal configured to be coupled to a reference potential, a battery interface circuit coupled to the second terminal and configured to be coupled to the reference potential, an adiabatic charge pump circuit coupled between the first terminal and the reference potential, and coupled to the battery interface circuit through a first inductor, and an inductive buck converter circuit coupled between the first terminal and the reference potential, and coupled to the battery interface circuit through a second inductor, wherein in a first mode of operation of the power converter circuit, the adiabatic charge pump circuit is deactivated, and the inductive buck converter circuit is activated, wherein in a second mode of operation of the power converter circuit, the adiabatic charge pump circuit is activated, and the inductive buck converter circuit is deactivated, and wherein the adiabatic charge pump circuit and the inductive buck converter circuit share the battery interface circuit and at least one of (1) a power switch coupled to the first terminal and a power switch coupled to the third terminal, (2) at least one fly capacitor, or (3) the first inductor.

The present invention also encompasses combinations of a Dickson charge pump with an inductive buck converter circuit such that all fly capacitors are shared, or in which some fly capacitors are shared. The present invention also encompasses an output current sensing circuit in combination with a charge pump that provides charge through an inductor L_{S} to an output capacitor C_{OUT}.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1A is a schematic diagram of one example of a prior art adiabatic two-phase 3-Level charge pump.

FIG. 1B is a schematic diagram of one example of a prior art 3-Level inductive buck converter.

FIG. 2A is a block diagram illustrating a first example battery management system.

FIG. 2B is a block diagram illustrating a second example battery management system.

FIG. 3A and FIG. 3B respectively illustrate example battery charging current and battery charging voltage graphs.

FIG. 4A is a schematic diagram of a first embodiment of combined charge pump and inductive buck converter circuits suitable for use in a battery management circuit.

FIG. 4B is a schematic diagram of the first type of battery interface circuit used in FIG. 4A.

FIG. 5 is a schematic diagram of a first variation of the first embodiment of combined charge pump and inductive buck converter circuits suitable for use in a battery management circuit.

FIG. 6A is a schematic diagram of a second variation of the first embodiment of combined charge pump and inductive buck converter circuits suitable for use in a battery management circuit.

FIG. 6B is a schematic diagram of the second type of battery interface circuit used in FIG. 6A.

FIG. 7 is a schematic diagram of a third variation of the first embodiment of combined charge pump and inductive buck converter circuits suitable for use in a battery management circuit.

FIG. 8 is a schematic diagram of a second embodiment of combined charge pump and inductive buck converter circuits suitable for use in a battery management circuit.

FIG. 9 is a schematic diagram of a variation of the second embodiment of combined charge pump and inductive buck converter circuits suitable for use in a battery management circuit.

FIG. 10 is a schematic diagram of a third embodiment of combined charge pump and inductive buck converter circuits suitable for use in a battery management circuit.

FIG. 11 is a schematic diagram of a first variation of the third embodiment of combined charge pump and inductive buck converter circuits suitable for use in a battery management circuit.

FIG. 12 is a schematic diagram of a second variation of the third embodiment of combined charge pump and inductive buck converter circuits suitable for use in a battery management circuit.

FIG. 13 is a schematic diagram of a third variation of the third embodiment of combined charge pump and inductive buck converter circuits suitable for use in a battery management circuit.

FIG. 14 is a schematic diagram of a fourth embodiment of combined charge pump and inductive buck converter circuits suitable for use in a battery management circuit.

FIG. 15 is a schematic diagram of a fifth embodiment of combined charge pump and inductive buck converter circuits suitable for use in a battery management circuit.

FIG. 16 is schematic diagram of a first embodiment of a multi-level, multi-phase charge pump and inductive buck converter circuit suitable for use as a battery management system.

FIG. 17 is schematic diagram of a second embodiment of a multi-level, multi-phase charge pump and inductive buck converter circuit suitable for use as a battery management system.

FIG. 18 is schematic diagram of a third embodiment of a multi-level, multi-phase charge pump and inductive buck converter circuit suitable for use as a battery management system.

FIG. 19 is a schematic diagram of a prior art divide-by-4 (4:1) dual-phase Dickson charge pump 1900.

FIG. 20 is a schematic diagram of a prior art 5-Level inductive buck converter.

FIG. 21 is schematic diagram of a first embodiment of a charge pump and inductive buck power converter circuit based on a dual-phase 4:1 (5-Level) Dickson charge pump and a two-phase 5-Level inductive buck converter.

FIG. 22 is schematic diagram of a second embodiment of a charge pump and inductive buck power converter circuit based on a dual-phase 4:1 (5-Level) Dickson charge pump and a two-phase 5-Level inductive buck converter.

FIG. 23 is schematic diagram of an embodiment of a charge pump and inductive buck power converter circuit based on a dual-phase 4:1 (5-Level) Dickson charge pump and a two-phase 3-Level inductive buck converter.

FIG. 24 shows a set of example graphs of output voltage and current as a function of time for a conventional switch mode power supply.

FIG. 25 shows a set of example graphs of output voltage and current as a function of time for a charge pump that provides charge through an inductor L_{S} to an output capacitor C_{OUT}.

FIG. 26 is a block diagram of a charge pump system that includes an output current sensing circuit.

FIG. 27 is a block diagram illustrating an example battery management system.

FIG. 28 is a top plan view of a substrate that may be, for example, a printed circuit board or chip module substrate (e.g., a thin-film tile).

FIG. 29 is a process flow chart showing one method for converting a first voltage to a second voltage.

Like reference numbers and designations in the various drawings generally indicate like elements, unless the context requires otherwise.

### DETAILED DESCRIPTION

The present invention encompasses battery management circuit configurations that can that provide a smaller and efficient solution.

### Battery Management Systems

Before considering the novel combined charge pump and inductive buck converter circuits suitable disclosed below, it may be useful to better understand novel examples of battery management systems in which such circuits may be particularly useful.

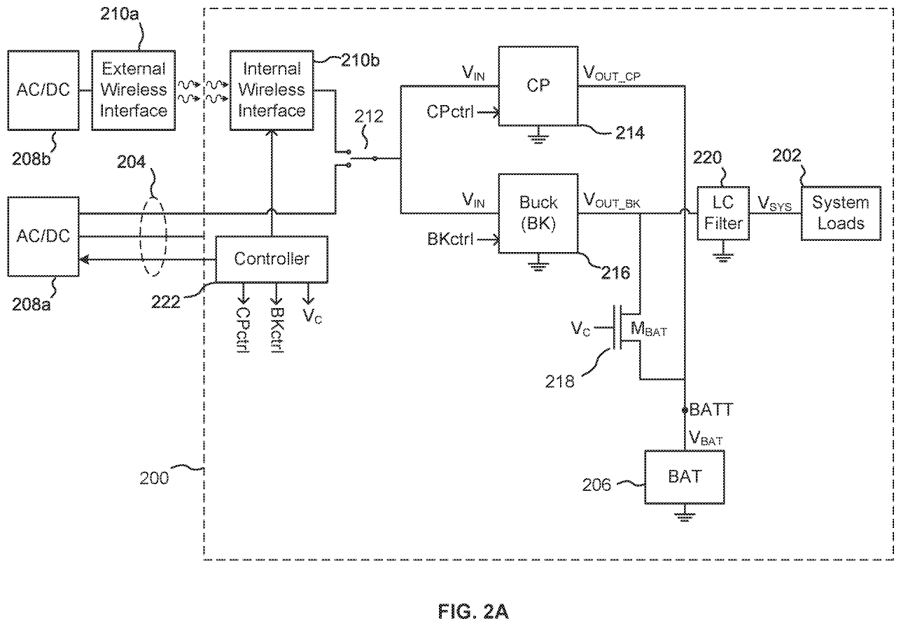

FIG. 2A is a block diagram illustrating a first example battery management system 200. The battery management system 200 may, for example, provide a voltage V_{SYS} to one or more system loads 202 (e.g., a smartphone, laptop, tablet computer, etc.). In the illustrated example, the battery management system 200 may receive power via a wired power delivery path 204 (e.g., USB-C, etc.) to support internal circuitry and/or to facilitate charging a battery 206. The wired power delivery path 204 may be coupled to an AC/DC adapter 208a external to the battery management system 200. In some embodiments, the wired power delivery path 204 may be replaced or supplemented by a wireless power delivery path comprising an external wireless interface 210a coupled to an AC/DC adapter 208b and an internal wireless interface 210b. The external wireless interface 210a and the internal wireless interface 210b may be, for example, components that comply with the Qi inductive wireless power transfer standard. The internal wireless interface 210b also may include power regulation circuitry such as a low-dropout (LDO) DC linear voltage regulator circuit. A selector switch 212 may select the AC/DC adapter 208a or the internal wireless interface 210b to provide an internal voltage V_{IN}.

The voltage V_{IN} is shown coupled to an input of a charge pump 214 and to an input of an inductive buck converter 216, each of which outputs a respective converted voltage V_{OUT_CP}, V_{OUT_BK}. In the illustrated example, the output V_{OUT_BK} of the inductive buck converter 216 provides a system voltage V_{SYS} to the system loads 202 and may be selectively coupled to the battery 206 through a switch M_{BAT} 218 (e.g., a field-effect transistor) in order to provide charge to the battery 206. The switch M_{BAT} 218 also serves to selectively provide a voltage VBAT to the system loads 202 when V_{OUT_BK} is insufficient (e.g., when the battery management system 200 is not connected to an AC/DC adapter 208). In the illustrated example, the output of the charge pump 214 is coupled directly to the battery 206 in order to provide charge to the battery 206.

In the illustrated example, an LC filter 220 is coupled on the V_{SYS} line. When switch M_{BAT} 218 is ON, that state introduces higher capacitances (such as those system loads 202 connected to V_{SYS}). Adding the LC filter 220 connected to the V_{SYS} line isolates the capacitances associated with system loads 202, and improves the efficiency of the charge pump 214 if the charge pump 214 does not have inductive elements. Redistribution losses in a charge pump are a function of the fly capacitance and output capacitance. Efficiency improves by increasing the fly capacitance and/or decreasing the output capacitance. The downside of increasing the fly capacitances can be larger size, and the downside of decreasing the output capacitance is increased ripple at the output. An LC filter 220 can remove output voltage ripple without sacrificing efficiency. There may be other optimal locations in which an LC filter could be placed as well.

In some embodiments, switches internal to the charge pump 214 and the inductive buck converter 216 may be used to select the AC/DC adapter 208a or the internal wireless interface 210b to provide the voltage V_{IN}, thus allowing the selector switch 212 to be omitted.

FIG. 2B is a block diagram illustrating a second example battery management system 200′. Similar in most respects to the first example battery management system 200 of FIG. 2A, the respective outputs V_{OUT_CP}, V_{OUT_BK} of the charge pump 214 and the inductive buck converter 216 provide the system voltage V_{SYS} to the system loads 202 and may be selectively coupled to the battery 206 through the switch M_{BAT} 218 in order to provide charge to the battery 206. The switch M_{BAT} 218 also serves to selectively provide a voltage VBAT to the system loads 202 when V_{OUT_CP} and V_{OUT_BK} are insufficient.

For the examples shown in FIGS. 2A and 2B, a controller 222 provides control signals to the charge pump 214, the inductive buck converter 216, the selector switch 212, and (optionally) to the AC/DC adapter 208 and/or to the internal wireless interface 210b to control the operation of those components in known fashion. For example, operation of a non-adiabatic charge pump power converter is described in U.S. Pat. No. 10,263,514 B1, issued Apr. 16, 2019, entitled Selectable Conversion Ratio DC-DC Converter, assigned to the assignee of the present invention and hereby incorporated by reference. Operation of an adiabatic charge pump power converter is described in U.S. Pat. No. 11,075,576 B2, issued Jul. 27, 2021, entitled Apparatus and Method for Efficient Shutdown of Adiabatic Charge Pumps, assigned to the assignee of the present invention and hereby incorporated by reference. Operation of an inductive buck power converter is described in U.S. Pat. No. 10,424,564 B2, issued Jun. 3, 2014, entitled Power Converters with Integrated Capacitors, assigned to the assignee of the present invention and hereby incorporated by reference.

It is common for the charge pump 214 and the inductive buck converter 216 to be implemented on separate integrated circuit (IC) chips connected to respective external fly capacitors and inductors. Note that while the battery 206 is shown as included within the battery management systems 200, 200′, the battery 206 may be an external component configured to be coupled to the illustrated battery management systems 200, 200′ circuitry through an appropriate terminal or node BATT.

### Battery Charging Management

Optimizing battery life while protecting against battery overcharging and thermal degradation can be complex, and often involves different types of charging phases to accommodate the charging/discharging, aging, and other characteristics of a particular battery type (lithium-ion, lithium polymer, etc.). For example, these phases may include a trickle charge phase, a pre-charge phase, a constant current (CC) phase, and/or a constant voltage (CV) or taper phase. In these or like charging phases, a battery management system may monitor one or more applicable temperatures, for example, and may reduce a charge current, such as if a particular monitored temperature meets or exceeds a specified threshold. A battery management system that includes both a charge pump and an inductive buck converter may select one or the other (or both) power converter as best fits the needs of a battery at the moment and the output characteristics of the selected power converter.

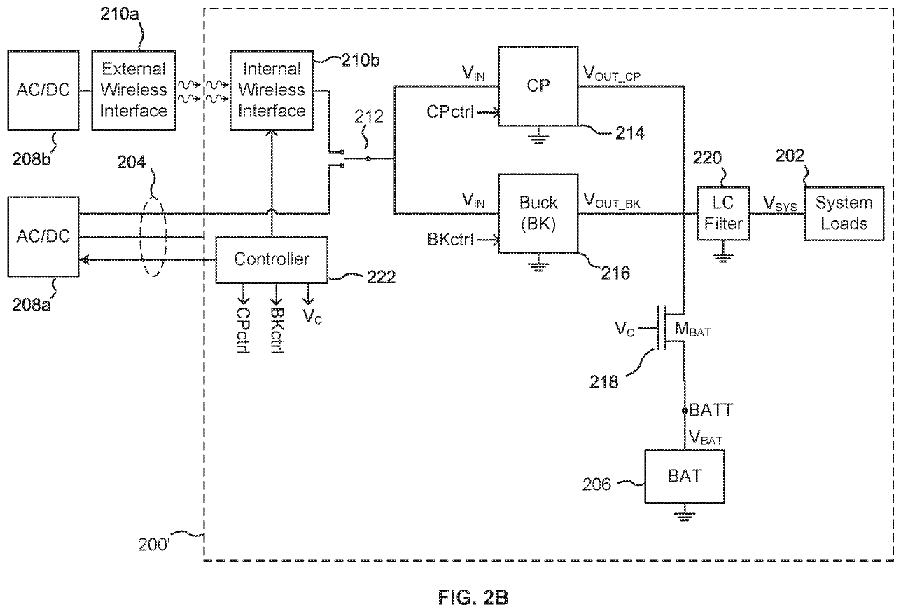

For example, FIG. 3A and FIG. 3B respectively illustrate example battery charging current and battery charging voltage graphs. Referring also to respective embedded tables 302a, 302b, an inductive buck converter (BK) charges a battery in a trickle charge phase with a trickle current ITC, and in a pre-charge phase with a pre-charge current I_{PC}. Once the battery voltage crosses a first threshold V_{CC1}, the battery may be charged with a first fast charging constant current I_{CC1}, again from the BK. Once the battery voltage crosses a second threshold V_{CC2}, the battery may be charged with a second fast charging constant current I_{CC2} from the charge pump (CP). As the battery voltage reaches VREG, the battery may be held at a constant voltage of VREG and the charge current from the CP may taper off as the battery approaches full charge. The point at which there is a switch-over from CP operation to BK operation in the constant voltage (taper) phase may be decided by various trigger points, such as, for example, time, voltage, current, or the like. If a battery current reaches I_{TERM}, charging is complete. In some instances, a battery management system may not need to traverse through all the zones (Z1-Z6) to complete battery charging, and thus may skip certain zones. In some applications, additional zones may be added.

Following are examples of a number of embodiments and variations of such embodiments of combined charge pump and inductive buck converter circuits suitable for use in a battery management circuit. Each circuit can be switched between a CP mode of operation and a BK mode of operation. Switching between CP and BK modes of operation is controlled in known fashion by a system controller to select various current and voltage battery charging modes, such as those shown in FIGS. 3A and 3B, adding only the necessary control signals to reconfigure the circuitry of a particular embodiment to activate or deactivate the CP and BK circuitry.

The example battery management systems shown in FIGS. 2A and 2B, when adapted to use any of the combined charge pump and inductive buck converter circuits disclosed below, may be particularly useful in variety of applications, such as (1) flash charging systems that can provide high power (tens to hundreds of kilowatts), and (2) applications that may need a programmable power supply (PPS), such as the USB-PPS standard, which allows for stepwise changes in current and voltage.

### First Embodiment

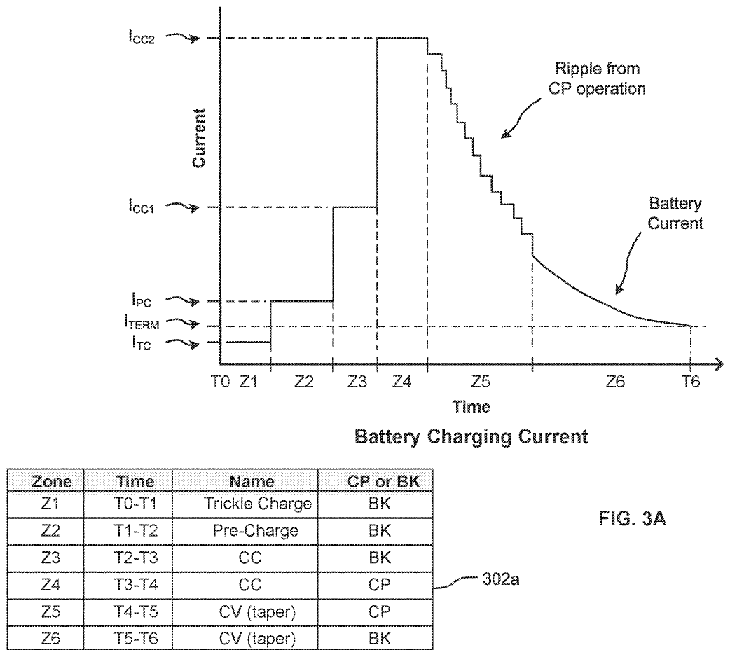

FIG. 4A is a schematic diagram of a first embodiment of combined charge pump and inductive buck converter circuits suitable for use in a battery management circuit. Two stacks of series-coupled power switches, S1-S4 and S5-S8, are coupled between an input terminal for V_{IN} and a reference terminal REF configured to be coupled to a reference potential (e.g., circuit ground). The power switches may be implemented using, for example, field-effect transistors (FETs). As shown, a first fly capacitor C1 is coupled between switch pairs S1-S2 and S3-S4, and a second fly capacitor C2 is coupled between switch pairs S5-S6 and S7-S8. A relatively small inductor L_{S} is coupled between switch pairs S6-S7 and a first type of battery interface (BI₁) circuit 402, which in turn is coupled to an output terminal for V_{SYS}. A relatively large inductor L_{B} (e.g., 2-100 times the inductance of L_{S}) is coupled between switch pairs S2-S3 and the BI₁ circuit 402.

FIG. 4B is a schematic diagram of the first type of battery interface circuit 402 used in FIG. 4A. The relatively large inductor L_{B} is coupled to the output terminal for V_{SYS}, to an output capacitor C_{OUT}, and to a first end of a conduction channel of a transistor M_{BAT}. A second end of the conduction channel of the transistor M_{BAT} is coupled to a shared battery capacitor C_{BAT} and to a battery 404. The relatively small inductor L_{S} is also coupled to the shared battery capacitor C_{BAT}, to the battery 404, and to the second end of the conduction channel of the transistor M_{BAT}. In some applications, the relatively small inductor L_{S} may also be connected to the output capacitor C_{OUT} and to the output terminal for V_{SYS} if transistor M_{BAT} is ON while the CP circuitry is operating.

The first type of battery interface circuit 402 may be modeled as a 4-terminal block having respective inputs for L_{B} and L_{S}, a reference potential terminal (e.g., to circuit ground), and the output terminal for V_{SYS}. A number of embodiments described below utilize the first type of battery interface circuit 402.

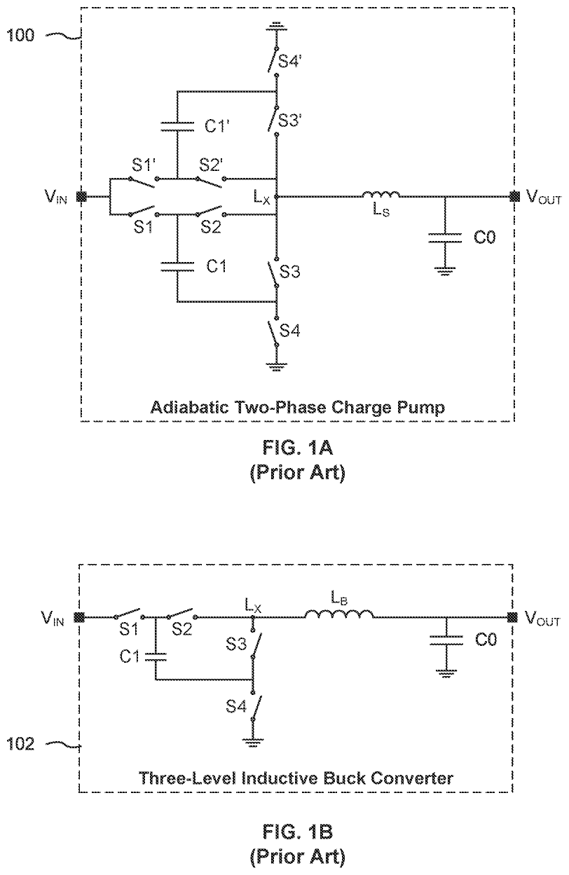

Referring back to FIG. 4A, the components comprising the BK circuitry include switches S1-S4, fly capacitor C1, inductor L_{B}, and the BI₁ circuit 402t. The presence of the fly capacitor C1 allows the buck converter circuitry to be operated as a 3-Level inductive buck converter. During BK operation, switches S5-S8 are opened (thus deactivating the charge pump circuitry), and switches S1-S4 are operated as described above with respect to FIG. 1B.

The components comprising the CP circuitry include switches S5-S8, fly capacitor C2, inductor L_{S}, and the BI₁ circuit 402. During CP operation, switches S1-S4 are opened (thus deactivating the BK circuitry), and switches S5-S8 are operated as described above with respect to one phase of FIG. 1A (mapping switches S5-S8 onto switches S1-S4 of FIG. 1A).

In the illustrated embodiment, the BI₁ circuit 402 is shared by the buck converter circuitry and the charge pump circuitry, and the output capacitor C_{OUT} and the shared battery capacitor C_{BAT} are coupled in parallel when transistor M_{BAT} is ON. Such a configuration may save components and layout space, or allow use of smaller-valued components, even if the buck converter circuitry and the charge pump circuitry are fabricated on separate IC chips (keeping in mind that the output capacitor C_{OUT} is generally an external off-chip component). Driving the various switches S1-S8 is straightforward, since the combined charge pump and inductive buck converter circuits can be effectively controlled as separate circuits that share only the BI₁ circuit 402.

Importantly, the inductors L_{B} and L_{S} for the buck converter circuitry and the charge pump circuitry are individually sized to optimize performance, efficiency, and layout space for those circuits.

TABLE 1 below summarizes the CP and BK circuitry configurations of the embodiment shown in FIG. 4A.

TABLE 1

| Configuration | Switches | Capacitors | Inductors | BI circuit |
|---|---|---|---|---|
| BK | S1-S4 | C1 | L_{B} | BI₁ |
| CP | S5-S8 | C2 | L_{S} | BI₁ |
| Shared components | — | — | — | BI₁ |

### First Variation of First Embodiment

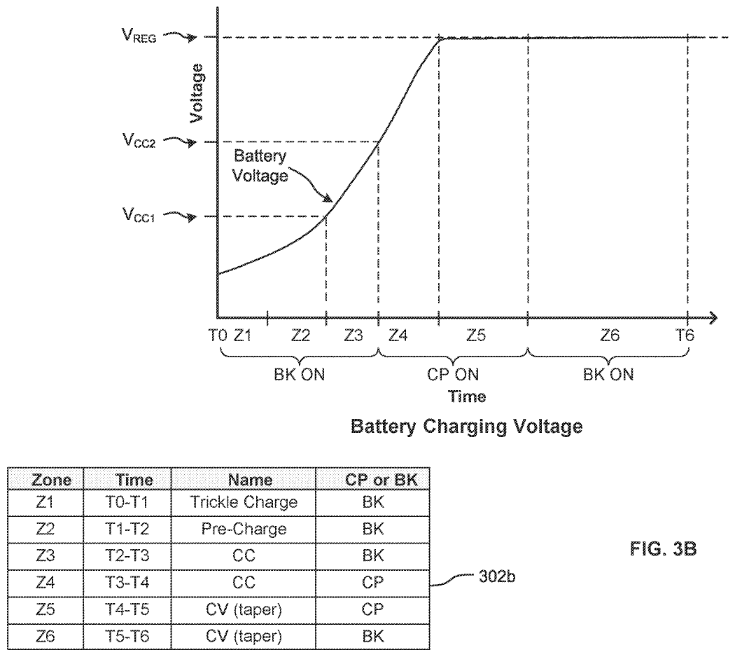

FIG. 5 is a schematic diagram of a first variation of the first embodiment of combined charge pump and inductive buck converter circuits suitable for use in a battery management circuit. Similar in most aspects to the circuit of FIG. 4A, an added conductor 502 couples switch pairs S1-S2 and S5-S6 as shown, and an added conductor 504 couples switch pairs S3-S4 and S7-S8 as shown. The added conductors 502, 504 effectively coupled capacitors C1 and C2 in parallel.

The components comprising the BK circuitry include switches S1-S4, fly capacitors C1 and C2, inductor L_{B}, and a BI₁ circuit 402. During BK operation, switches S5-S8 are opened (thus deactivating the CP circuitry), and switches S1-S4 are operated as described above with respect to FIG. 1B. Since the capacitance of capacitors coupled in parallel is additive (e.g., the capacitance of C1∥C2=C1+C2), the presence of the fly capacitors C1 and C2 coupled in parallel allows the BK circuitry to be operated as a 3-Level inductive buck converter but with a larger fly capacitance compared to the circuit of FIG. 4A or with smaller capacitor components (or a combination of smaller capacitor components having a larger total capacitance than a single capacitor). In certain scenarios, one of the capacitors C1, C2 may be omitted if the capacitance of the other capacitor is sufficiently large.

The components comprising the CP circuitry include switches S5-S8, fly capacitors C1 and C2, inductor L_{S}, and the BI₁ circuit 402. During CP operation, switches S1-S4 are opened (thus deactivating the BK circuitry), and switches S5-S8 are operated as described above with respect to one phase of FIG. 1A (mapping switches S5-S8 onto switches S1-S4 of FIG. 1A). Again, the presence of the fly capacitors C1 and C2 coupled in parallel allows the CP circuitry to be operated as a charge pump but with a larger fly capacitance compared to the circuit of FIG. 4A or with smaller capacitor components (or a combination of smaller capacitor components having a larger total capacitance than a single capacitor). As noted above, one of the capacitors C1, C2 may be omitted if the capacitance of the other capacitor is sufficiently large for a particular application.

TABLE 2 below summarizes the CP and BK circuitry configurations of the embodiment shown in FIG. 5.

TABLE 2

| Configuration | Switches | Capacitors | Inductors | BI circuit |
|---|---|---|---|---|
| BK | S1-S4 | C1, C2 | L_{B} | BI₁ |
| CP | S5-S8 | C1, C2 | L_{S} | BI₁ |
| Shared | — | C1, C2 | — | BI₁ |
| components | | | | |

### Second Variation of First Embodiment

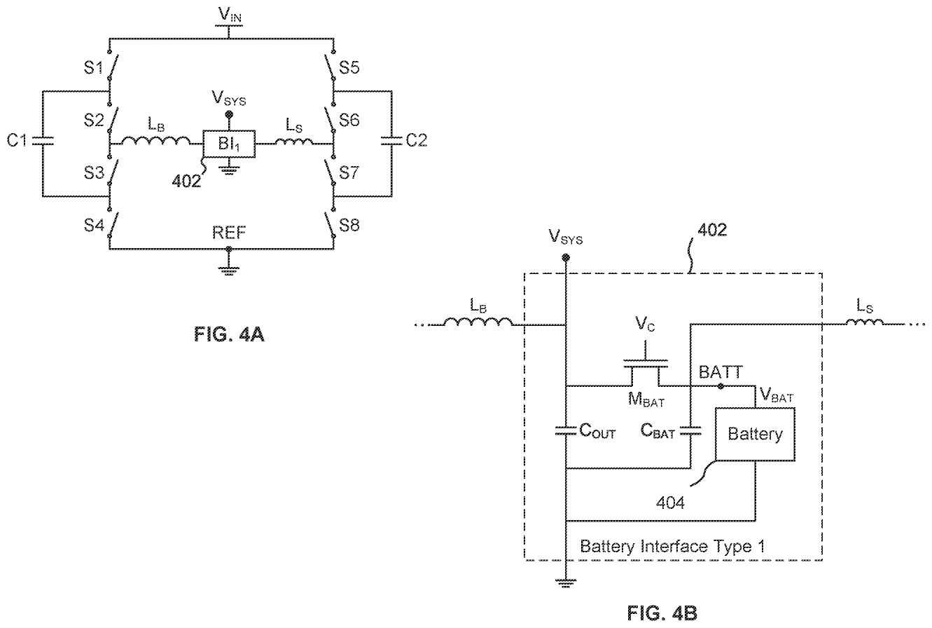

FIG. 6A is a schematic diagram of a second variation of the first embodiment of combined charge pump and inductive buck converter circuits suitable for use in a battery management circuit. Similar in most aspects to the circuit of FIG. 4A, inductor L_{B} is coupled as shown through inductor L_{S} to a second type of battery interface circuit (BI₂) circuit 602.

FIG. 6B is a schematic diagram of the second type of battery interface circuit 602 used in FIG. 6A. The relatively large inductor L_{B} and the relatively small inductor L_{S} are series coupled, in some configurations, as L_{B}+L_{S}, while in other configurations, as L_{S}+L_{B}. The series-coupled inductors L_{B}, L_{S} are in turn coupled to the output terminal for V_{SYS}, to an output capacitor C_{OUT}, and to a first end of a conduction channel of a transistor M_{BAT}. A second end of the conduction channel of the transistor M_{BAT} is coupled to a shared battery capacitor C_{BAT} and to a battery 604. A low-resistance bypass switch S_{BP0} coupled in parallel with the transistor M_{BAT} may be used in some applications to provide a lower resistance signal path compared to the ON state of the transistor M_{BAT}. This capability may be particularly useful when the only operating power converter is a charge pump circuit that directly charges the battery 604, since the relatively high resistance of the transistor M_{BAT} would reduce overall efficiency. Accordingly, in general, transistor M_{BAT} is set to a closed (ON) state when a coupled charge pump is actively operating.

The second type of battery interface circuit 602 may be modeled as a 3-terminal block having an input for the series-coupled inductors L_{B}, L_{S}, a reference potential terminal (e.g., to circuit ground), and the output terminal for V_{SYS}. A number of embodiments described below utilize the second type of battery interface circuit 602.

Note that the BI₁ circuit 402 and the BI₂ circuit 602 are only slight variants of each other, and that the BI₂ circuit 602 may be used in all cases by appropriately setting the state of the bypass switch S_{BP0} and connecting the small inductor L_{S} to the BATT node to configure as a BI₁ circuit 402 (thus making the circuit a 4-terminal block).

The components comprising the BK circuitry include switches S1-S4, fly capacitor C1, inductors L_{B}+L_{S}, and the BI₂ circuit 602. During BK operation, switches S5-S8 are opened (thus deactivating the CP circuitry), and switches S1-S4 are operated as described above with respect to FIG. 1B. The series coupling of the inductors L_{B} and L_{S} allows the inductor L_{B} to have a lesser inductance (by about the inductance of L_{S}) compared to the embodiment of FIG. 4A, and thus inductor L_{B} may be a physically smaller component than in the embodiment of FIG. 4A. For example, if the inductor L_{B} in the circuit of FIG. 4A has an inductance about 10 times greater than the inductance of L_{S}, then the inductor L_{B} in the circuit of FIG. 6A may need an inductance only about 9 times greater than the inductance of L_{S} since the inductance of L_{S} will be added to the inductance of L_{B} during BK operation.

The components comprising the CP circuitry include switches S5-S8, fly capacitor C2, inductor L_{S}, and the BI₂ circuit 602. During CP operation, switches S1-S4 are opened (thus deactivating the BK circuitry), and switches S5-S8 are operated as described above with respect to one phase of FIG. 1A (mapping switches S5-S8 onto switches S1-S4 of FIG. 1A).

TABLE 3 below summarizes the CP and BK circuitry configurations of the embodiment shown in FIG. 6A.

TABLE 3

| Configuration | Switches | Capacitors | Inductors | BI circuit |
|---|---|---|---|---|
| BK | S1-S4 | C1 | L_{B} + L_{S} | BI₂ |
| CP | S5-S8 | C2 | L_{S} | BI₂ |
| Shared | — | — | L_{S} | BI₂ |
| components | | | | |

### Third Variation of First Embodiment

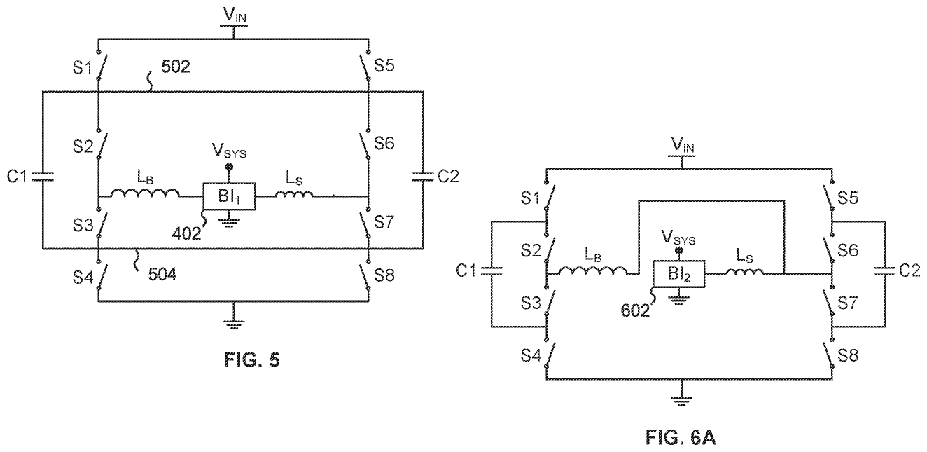

FIG. 7 is a schematic diagram of a third variation of the first embodiment of combined charge pump and inductive buck converter circuits suitable for use in a battery management circuit. Similar in most aspects to the circuit of FIG. 6A, an added conductor 702 couples switch pairs S1-S2 and S5-S6 as shown, and an added conductor 704 couples switch pairs S3-S4 and S7-S8 as shown. As in the circuit of FIG. 5, the added conductors 702, 704 effectively couple capacitors C1 and C2 in parallel.

The components comprising the BK circuitry include switches S1-S4, fly capacitors C1 and C2, inductors L_{B}+L_{S}, and a BI₂ circuit 602. During BK operation, switches S5-S8 are opened (thus deactivating the CP circuitry), and switches S1-S4 are operated as described above with respect to FIG. 1B. The series coupling of the inductors L_{B} and L_{S} allows the inductor L_{B} to have a lesser inductance (by about the inductance of L_{S}) compared to the embodiment of FIG. 4A, and thus inductor L_{B} may be a physically smaller component than the embodiment of FIG. 4A. The presence of the fly capacitors C1 and C2 coupled in parallel allows the BK circuitry to be operated as a 3-Level inductive buck converter but with a larger fly capacitance compared to the circuit of FIG. 4A or with smaller capacitor components (or a combination of smaller capacitor components having a larger total capacitance than a single capacitor).

The components comprising the CP circuitry include switches S5-S8, fly capacitors C1 and C2, inductor L_{S}, and the BI₂ circuit 602. During CP operation, switches S1-S4 are opened (thus deactivating the BK circuitry), and switches S5-S8 are operated as described above with respect to one phase of FIG. 1A (mapping switches S5-S8 onto switches S1-S4 of FIG. 1A).

TABLE 4 below summarizes the CP and BK circuitry configurations of the embodiment shown in FIG. 7.

TABLE 4

| Configuration | Switches | Capacitors | Inductors | BI circuit |
|---|---|---|---|---|
| BK | S1-S4 | C1, C2 | L_{B} + L_{S} | BI₂ |
| CP | S5-S8 | C1, C2 | L_{S} | BI₂ |
| Shared | — | C1, C2 | L_{S} | BI₂ |
| components | | | | |

### Second Embodiment

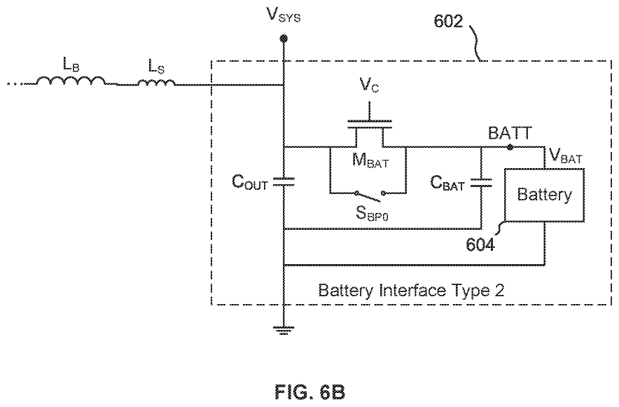

FIG. 8 is a schematic diagram of a second embodiment of combined charge pump and inductive buck converter circuits suitable for use in a battery management circuit. A single stack of series-coupled power switches S1-S4 are coupled between an input terminal for V_{IN} and a reference terminal. As shown, a fly capacitor C1 is coupled between switch pairs S1-S2 and S3-S4. A relatively small inductor L_{S} is coupled between switch pairs S2-S3 and a relatively large inductor L_{B} (e.g., 2-100 times the inductance of L_{S}), which in turn is coupled to a BI₂ circuit 602. A bypass switch SBP is coupled in parallel with inductor L_{B}. When bypass switch SBP is closed, the inductance between switch pairs S2-S3 and the BI₂ circuit 602 is just L_{S}, while when bypass switch SBP is opened, the inductance between switch pairs S2-S3 and the BI₂ circuit 602 is L_{S}+L_{B}.

The components comprising the BK circuitry include switches S1-S4, fly capacitor C1, inductors L_{S}+L_{B} (bypass switch SBP being opened), and the BI₂ circuit 602. The presence of the fly capacitor C1 allows the buck converter circuitry to be operated as a 3-Level inductive buck converter. During BK operation, bypass switch SBP is opened (thus effectively blocking L_{B} from influencing the circuit), and switches S1-S4 are operated as described above with respect to FIG. 1B.

The components comprising the CP circuitry include switches S1-S4, fly capacitor C1, inductor L_{S} (bypass switch SBP being closed), and the BI₂ circuit 602. During CP operation, switches S1-S4 are operated as described above with respect to one phase of FIG. 1A (switches S1-S4 corresponding to switches S1-S4 of FIG. 1A).

Notably, the embodiment of FIG. 8 allows a substantial sharing of components compared to the embodiment of FIG. 4A, with half of the power switches (S1-S4 versus S1-S8) and one fewer capacitor (no C2). Further, the series coupling of the inductors L_{B} and L_{S} allows the inductor L_{B} to have a lesser inductance (by about the inductance of L_{S}) compared to the embodiment of FIG. 4A, and thus inductor L_{B} may be a physically smaller component than the embodiment of FIG. 4A.

TABLE 5 below summarizes the CP and BK circuitry configurations of the embodiment shown in FIG. 8.

TABLE 5

| Configuration | Switches | Capacitors | Inductors | BI circuit |
|---|---|---|---|---|
| BK | S1-S4 | C1 | L_{B} + L_{S} | BI₂ |
| CP | S1-S4 | C1 | L_{S} | BI₂ |
| Shared | S1-S4 | C1 | L_{S} | BI₂ |
| components | | | | |

### Variation of Second Embodiment

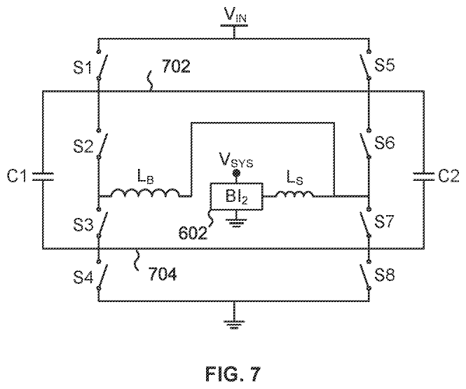

FIG. 9 is a schematic diagram of a variation of the second embodiment of combined charge pump and inductive buck converter circuits suitable for use in a battery management circuit. The illustrated example allows for a two-phase charge pump when in CP mode. Dual parallel stacks of series switches S1-S4, S1′-S4′ are coupled between an input terminal for V_{IN} and a reference terminal. As shown, fly capacitors C1, C1′ are respectively coupled between switch pairs S1-S2 and S3-S4 and between switch pairs S1′-S2′ and S3′-S4′. Relatively small inductors L_{S}, L_{S}′ are respectively coupled between switch pairs S2-S3, S2′-S3′ and a relatively large inductor L_{B} (e.g., 2-100 times the inductance of L_{S}), which in turn is coupled to a BI₂ circuit 602. In some embodiments, the pair of small inductors L_{S}, L_{S}′ may be replaced by a single inductor L_{S} coupled between inductor L_{B} and both nodes L_{X} and L_{X}′, as in FIG. 1A.

A bypass switch SBP is coupled in parallel with inductor L_{B}. When bypass switch SBP is closed, the inductance between switch pairs S2-S3 and S2′-S3′ and the BI₂ circuit 602 is respectively just L_{S}, L_{S}′. When bypass switch SBP is opened, the inductance between switch pairs S2-S3 and S2′-S3′ and the BI₂ circuit 602 is respectively L_{S}+L_{B}, L_{S}′+L_{B}.

The components comprising the BK circuitry include switches S1-S4, S1′-S4′, fly capacitors C1, C1′, inductors L_{S}+L_{B} and L_{S}′+L_{B} (bypass switch SBP being opened), and the BI₂ circuit 602. The presence of the fly capacitors C1, C1′ allows the BK circuitry to be operated as a 3-Level inductive buck converter. During BK operation, bypass switch SBP is opened (thus deactivating the charge pump circuitry), and switches S1-S4, S1′-S4′ may be operated as described above with respect to FIG. 1B, with corresponding switches (S1 & S1′, S2 & S2′, S3 & S3′, and S4 & S4′) being operated in unison rather than with opposite phasing as in the CP mode of operation. Accordingly, during BK operation, the BK circuitry may effectively comprise two parallel legs operating concurrently and in phase—that is, a dual-leg BK circuit configuration. Alternatively, when using two separate sets of inductors L_{S}, L_{S}′, and L_{B}, L_{B}′ (L_{B}′ is not shown), the BK circuitry may be operated out of phase (in embodiments with only a single inductor L_{S}, BK operation needs to run in phase).

The components comprising the CP circuitry include switches S1-S4, S1′-S4′, fly capacitors C1, C1′, inductors L_{S}, L_{S}′ (bypass switch SBP being closed), and the BI₂ circuit 602. During CP operation, switches S1-S4, S1′-S4′ are operated as described above with respect to FIG. 1A. Thus, corresponding switches (S1 & S1′, S2 & S2′, S3 & S3′, and S4 & S4′) are operated with opposite phasing. Alternatively, the switches may be operated in phase.

TABLE 6 below summarizes the CP and BK circuitry configurations of the embodiment shown in FIG. 9 when using dual small inductors L_{S}, L_{S}′.

TABLE 6

| Configuration | Switches | Capacitors | Inductors | BI circuit |
|---|---|---|---|---|
| BK | S1-S4, S1′-S4′ | C1, C1′ | L_{B} + L_{S}, | BI₂ |
| | | | L_{B} + L_{S}′ | |
| CP | S1-S4, S1′-S4′ | C1, C1′ | L_{S}, L_{S}′ | BI₂ |
| Shared | S1-S4, S1′-S4′ | C1, C1′ | L_{S}, L_{S}′ | BI₂ |
| components | | | | |

### Third Embodiment

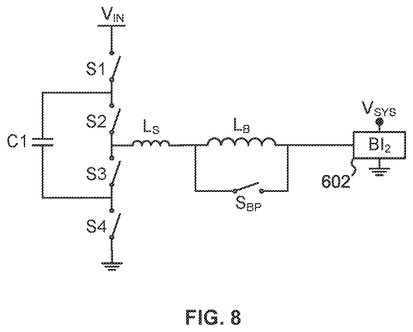

FIG. 10 is a schematic diagram of a third embodiment of combined charge pump and inductive buck converter circuits suitable for use in a battery management circuit. A first functional stack of series-coupled power switches S1, S2, S3, and S6 are coupled between an input terminal for V_{IN} and a reference terminal, while a second functional stack of series switches S1, S4, S5, and S6 are coupled between the input terminal and the reference terminal. Thus, switches S1 and S6 are shared between both functional stacks.

As shown, a fly capacitor C1 is coupled between shared switches S1 and S6. A relatively small inductor L_{S} is coupled between switch pairs S4-S5 and a BI₁ circuit 402. A relatively large inductor L_{B} (e.g., 2-100 times the inductance of L_{S}) is coupled between switch pairs S2-S3 and the BI₁ circuit 402.

The components comprising the BK circuitry include switches S1, S2, S3, and S6, fly capacitor C1, inductor L_{B}, and the BI₁ circuit 402. The presence of the fly capacitor C1 allows the buck converter circuitry to be operated as a 3-Level inductive buck converter. During BK operation, switches S4-S5 are opened (thus deactivating the charge pump circuitry), and switches S1, S2, S3, and S6 are operated as described above with respect to FIG. 1B (mapping switches S1, S2, S3, and S6 onto switches S1-S4 of FIG. 1B).

The components comprising the CP circuitry include switches S1, S4, S5, and S6, fly capacitor C1, inductor L_{S}, and the BI₁ circuit 402. During CP operation, switches S2-S3 are opened (thus deactivating the BK circuitry), and switches S1, S4, S5, and S6 are operated as described above with respect to one phase of FIG. 1A (mapping switches S1, S4, S5, and S6 onto switches S1-S4 of FIG. 1A).

Notably, the embodiment of FIG. 10 allows a substantial sharing of components compared to the embodiment of FIG. 4A, with two fewer power switches (S1-S6 versus S1-S8) and one fewer capacitor (no C2). Further, compared to the embodiment of FIG. 8, omitting the bypass switch SBP avoids adding an additional output resistance to the low resistance inductor L_{S}.

While the embodiment of FIG. 10 is shown with capacitor C1, thus enabling 3-Level BK operation, capacitor C1 may be effectively bypassed to as to configure the embodiment for 2-Level BK operation by either setting switches S1 and S6 to always ON during BK operation, or by ganging switches S1 & S2 and switches S3 & S6 to always switch in unison during BK operation.

TABLE 7 below summarizes the CP and BK circuitry configurations of the embodiment shown in FIG. 10 when enabled to support 3-Level BK operation.

TABLE 7

| Configuration | Switches | Capacitors | Inductors | BI circuit |
|---|---|---|---|---|
| BK | S1, S2, S3, S6 | C1 | L_{B} | BI₁ |
| CP | S1, S4, S5, S6 | C1 | L_{S} | BI₁ |
| Shared | S1, S6 | C1 | — | BI₁ |
| components | | | | |

### First Variation of Third Embodiment

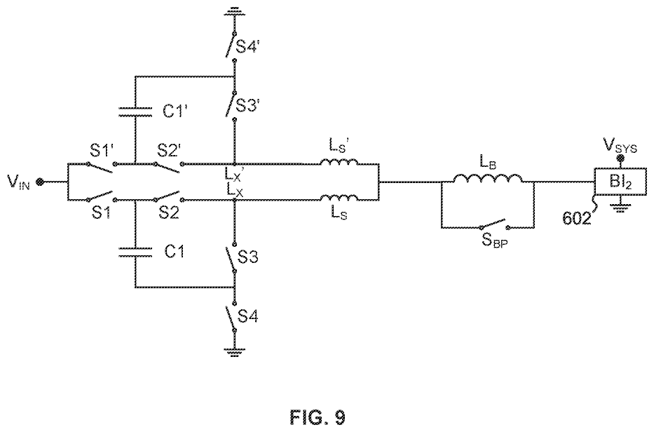

FIG. 11 is a schematic diagram of a first variation of the third embodiment of combined charge pump and inductive buck converter circuits suitable for use in a battery management circuit. Similar in most aspects to the circuit of FIG. 10, inductor L_{B} is coupled as shown through inductor L_{S} to a BI₂ circuit 602.

The components comprising the BK circuitry include switches S1, S2, S3, S6, fly capacitor C1, inductors L_{B}+L_{S}, and the BI₂ circuit 602. The presence of the fly capacitor C1 allows the buck converter circuitry to be operated as a 3-Level inductive buck converter. During BK operation, switches S4-S5 are opened (thus deactivating the charge pump circuitry), and switches S1, S2, S3, S6 are operated as described above with respect to FIG. 1B (mapping switches S1, S2, S3, S6 onto switches S1-S4 of FIG. 1B). The series coupling of the inductors L_{B} and L_{S} allows the inductor L_{B} to have a lesser inductance (by about the inductance of L_{S}) compared to the embodiment of FIG. 10, and thus inductor L_{B} may be a physically smaller component than the embodiment of FIG. 10.

The components comprising the CP circuitry include switches S1, S4, S5, S6, fly capacitor C1, inductor L_{S}, and the BI₂ circuit 602. During CP operation, switches S2-S3 are opened (thus deactivating the BK circuitry), and switches S1, S4, S5, S6 are operated as described above with respect to one phase of FIG. 1A (mapping switches S1, S4, S5, S6 onto switches S1-S4 of FIG. 1A).

While the embodiment of FIG. 11 is shown with capacitor C1, thus enabling 3-Level BK operation, capacitor C1 may be effectively bypassed to as to configure the embodiment for 2-Level BK operation by either setting switches S1 and S6 to always ON during BK operation, or by ganging switches S1 & S2 and switches S3 & S6 to always switch in unison during BK operation.

TABLE 8 below summarizes the CP and BK circuitry configurations of the embodiment shown in FIG. 11 when enabled to support 3-Level BK operation.

TABLE 8

| Configuration | Switches | Capacitors | Inductors | BI circuit |
|---|---|---|---|---|
| BK | S1, S2, S3, S6 | C1 | L_{B} + L_{S} | BI₂ |
| CP | S1, S4, S5, S6 | C1 | L_{S} | BI₂ |
| Shared | S1, S6 | C1 | L_{S} | BI₂ |
| components | | | | |

### Second Variation of Third Embodiment

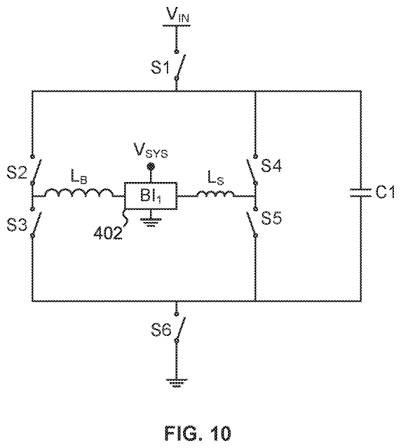

FIG. 12 is a schematic diagram of a second variation of the third embodiment of combined charge pump and inductive buck converter circuits suitable for use in a battery management circuit. Similar in most aspects to the circuit of FIG. 10, two switches S7, S8 and a second fly capacitor C2 have been added to enable 4-Level BK operation. More specifically, as shown switch S7 is interposed between the input terminal for V_{IN} and switch S1, and switch S8 is interposed between switch S6 and the reference terminal, while capacitor C2 is coupled in series between switches S7 and S8.

The components comprising the BK circuitry include switches S1, S2, S3, S6, S7, and S8, fly capacitors C1 and C2, inductor L_{B}, and a BI₁ circuit 402. The presence of the fly capacitors C1 and C2 allows the buck converter circuitry to be operated as a 4-Level inductive buck converter. During BK operation, switches S4-S5 are opened (thus deactivating the charge pump circuitry), and switches S1, S2, S3, S6, S7, and S8, are operated in known fashion for a multi-level buck converter. One method of operating a multi-level power converter is disclosed in U.S. patent application Ser. No. 17/560,767, filed Dec. 23, 2021, entitled Controlling Charge-Balance and Transients in a Multi-Level Power Converter, assigned to the assignee of the present invention and hereby incorporated by reference.

The components comprising the CP circuitry include switches S1, S4, S5, S6, S7, S8, fly capacitors C1 and C2, inductor L_{S}, and the BI₁ circuit 402. In a first mode of CP operation, switches S2-S3 are opened (thus deactivating the BK circuitry), switches S7 and S8 are closed, and switches S1, S4, S5, and S6 are operated as described above with respect to one phase of FIG. 1A (mapping switches S1, S4, S5, and S6 onto switches S1-S4 of FIG. 1A). The presence of the fly capacitor C1 allows the CP circuitry to be operated as a 3-Level (2:1) charge pump. In a second mode of CP operation, switches S2-S3 are opened (thus deactivating the BK circuitry), and switches S1, S4-S8 are operated in one of several possible known state sequences to balance all of the fly capacitors and output a desired voltage at V_{SYS}. The presence of the fly capacitors C1 and C2 allows the CP circuitry to be operated as a 4-Level (3:1) charge pump. In general, as the Level of a charge pump increases, the number of intermediate voltage states needs to increase to balance all of fly capacitors.

Note that enabling 4-Level BK operation and CP operation by adding capacitor C2 allows the possible use of smaller capacitors for C1 and C2 and lower voltage switches, since the voltage across any one switch is reduced compared to the circuit configuration of FIG. 10.

As with the embodiments of FIGS. 10 and 11, lesser levels of BK operation (e.g., 3-Level or 2-Level) can be enabled by setting various switches to always ON or in ganged operation to effectively bypass one or both of the fly capacitors C1 and C2. For example, 2-Level operation can be achieved by either setting switches S1 & S7 and S6 & S8 to always ON during BK operation, or by ganging switches S1 & S2 & S7 and switches S3 & S6 & S8 to always switch in unison during BK operation. Lesser levels of CP operation may be enabled in the same manner.

TABLE 9 below summarizes the CP and BK circuitry configurations of the embodiment shown in FIG. 12 when enabled to support 4-Level BK and CP operation.

TABLE 9

| Configuration | Switches | Capacitors | Inductors | BI circuit |
|---|---|---|---|---|
| BK | S1, S2, S3, S6, | C1, C2 | L_{B} | BI₁ |
| | S7, S8 | | | |
| CP | S1, S4, S5, S6, | C1, C2 | L_{S} | BI₁ |
| | S7, S8 | | | |
| Shared | S1, S6, S7, S8 | C1, C2 | — | BI₁ |
| components | | | | |

### Third Variation of Third Embodiment

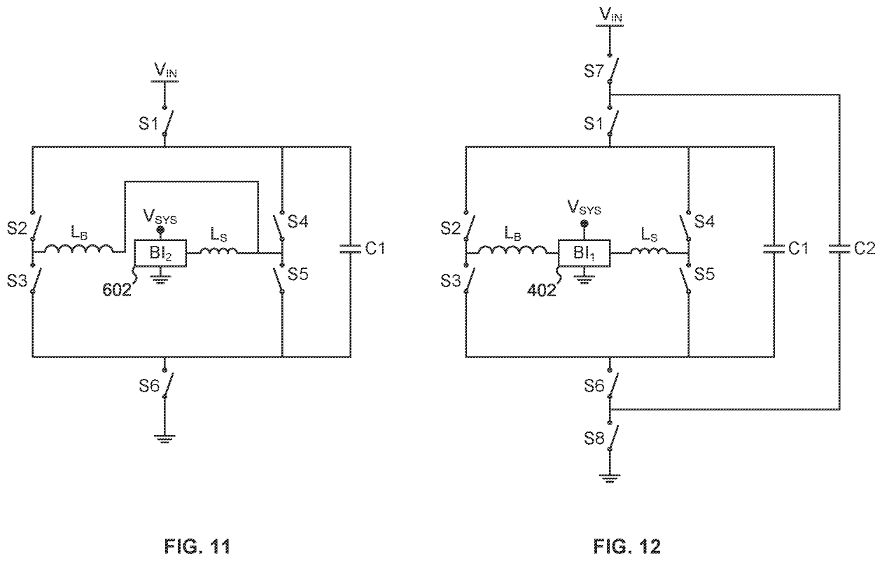

FIG. 13 is a schematic diagram of a third variation of the third embodiment of combined charge pump and inductive buck converter circuits suitable for use in a battery management circuit. Similar in most aspects to the circuit of FIG. 10, the illustrated example allows for a two-phase charge pump when in CP mode.

Dual parallel stacks of series switches S1, S4, S5, S6 and S1′, S4′, S5′, S6′ are coupled between an input terminal for V_{IN} and a reference terminal. As shown, fly capacitors C1, C1′ are respectively coupled between switch pairs S1 & S4 and S5 & S6 and between switch pairs S1′ & S4′ and S5′ & S6′. A relatively small shared inductor L_{S} is coupled between a BI₁ circuit 402 and switch pairs S4-S5 and S4′-S5′. Note that two separate small inductors, L_{S} and L_{S}′, as in in FIG. 9, may be used in alternative embodiments of the illustrated circuit. A relatively large inductor L_{B} (e.g., 2-100 times the inductance of L_{S}) is coupled between the BI₁ circuit 402 and switch pairs S2-S3, as in FIG. 10.

The components comprising the BK circuitry include switches S1, S2, S3, and S6, fly capacitor C1, inductor L_{B}, and the BI₁ circuit 402. The presence of the fly capacitor C1 allows the buck converter circuitry to be operated as a 3-Level inductive buck converter. During BK operation, switches S4-S5, S4′-S5′ are opened (thus deactivating the charge pump circuitry), and switches S1, S2, S3, and S6 are operated as described above with respect to FIG. 1B (mapping switches S1, S2, S3, and S6 onto switches S1-S4 of FIG. 1B).

The components comprising the two-phase CP circuitry include switches S1, S4, S5, S6 and S1′, S4′, S5′, S6′, fly capacitors C1, C1′, inductor L_{S}, and the BI₁ circuit 402. During CP operation, switches S1, S4, S5, S6 and S1′, S4′, S5′, S6′ are operated as described above with respect to FIG. 1A (mapping S1, S4, S5, S6 and S1′, S4′, S5′, S6′ to S1-S4 and S1′-S4′, respectively). Thus, corresponding switches (S1 & S1′, S4 & S4′, S4 & S4′, and S6 & S6′) are operated with opposite phasing.

TABLE 10 below summarizes the CP and BK circuitry configurations of the embodiment shown in FIG. 13.

TABLE 10

| Configuration | Switches | Capacitors | Inductors | BI circuit |
|---|---|---|---|---|
| BK | S1, S2, S3, S6 | C1 | L_{B} | BI₁ |
| CP | S1, S4, S5, S6 & | C1, C1′ | L_{S}, | BI₁ |
| | S1′, S4′, S5′, S6′ | | | |
| Shared | S1, S6 | C1 | L_{S} | BI₁ |
| components | | | | |

### Fourth Embodiment

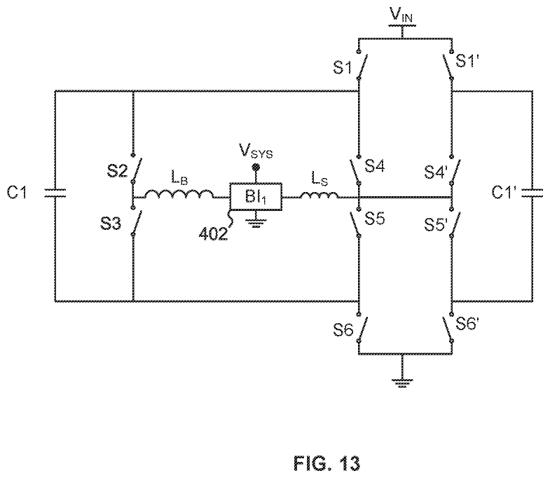

FIG. 14 is a schematic diagram of a fourth embodiment of combined charge pump and inductive buck converter circuits suitable for use in a battery management circuit. The illustrated example allows for a two-phase charge pump when in CP mode, and dual shared fly capacitors when in BK mode. Use of dual shared fly capacitors results in less voltage ripple at the output, which in turn allows use of lower voltage power switches.

Dual parallel stacks of series-coupled power switches S1-S4, S5-S8 are coupled between an input terminal for V_{IN} and a reference terminal. Series-coupled power switches S9 and S10 are coupled in parallel with series-coupled switches S2 and S3, and series-coupled power switches S11 and S12 are coupled in parallel with series-coupled switches S6 and S7. As shown, a fly capacitor C1 is coupled in series between switches S1 and S4, and a fly capacitor C2 is coupled in series between switches S5 and S8. A relatively small inductor L_{S} is coupled between both switch pairs S2-S3 and S6-S7 and a BI₁ circuit 402, as shown. A relatively large inductor L_{B} (e.g., 2-100 times the inductance of L_{S}), is coupled between both switch pairs S9-S10 and S11-S12 and the BI₁ circuit 402.

In the illustrated example, the components comprising the BK circuitry essentially form two parallel BK circuits. The components comprising the first parallel BK circuitry include switches S1, S9, S10, & S4, fly capacitor C1, inductor L_{B}, and the BI₁ circuit 402. The components comprising the second parallel BK circuitry include switches S5, S11, S12, & S8, fly capacitor C2, inductor L_{B}, and the BI₁ circuit 402. The presence of the fly capacitors C1, C2 allows the parallel BK circuitry to be operated as a 3-Level inductive buck converter. During BK operation, switches S2-S3 and S6-S7 are opened (thus deactivating the charge pump circuitry), and switch sets S1, S9, S10, & S4 and S5, S11, S12, & S8 are operated as described above with respect to FIG. 1B (mapping each set switch set S1, S9, S10, & S4 and S5, S11, S12, & S8 onto switches S1-S4 of FIG. 1B).

In the illustrated example, the components comprising the CP circuitry essentially form two parallel CP circuits, generally operated on opposite phases (i.e., the CP circuitry may be operated as a two-phase charge pump). The components comprising the first phase CP circuitry include switches S1-S4, fly capacitor C1, inductor L_{S}, and the BI₁ circuit 402. The components comprising the second phase CP circuitry include switches S5-S8, fly capacitor C2, inductor L_{S}, and the BI₁ circuit 402. During CP operation, switches S9, S10, S11, and S12 are opened (thus deactivating the BK circuitry), and switch sets S1-S4 and S5-S8 are operated in a phase interleaved manner as described above with respect to FIG. 1A (mapping switches S5-S8 onto switches S1′-S4′ of FIG. 1A).

While the embodiment of FIG. 14 is shown with two parallel BK circuits each having a respective capacitor C1, C2, thus enabling 3-Level BK operation, the capacitors may be effectively bypassed to as to configure the embodiment for 2-Level BK operation, for example, by ganging switches S9 & S11 and S10 & S12 to always switch in unison during BK operation.

TABLE 11 below summarizes the CP and BK circuitry configurations of the embodiment shown in FIG. 14 when enabled to support 3-Level BK operation.

TABLE 11

| Configuration | Switches | Capacitors | Inductors | BI circuit |
|---|---|---|---|---|
| BK | S1, S9, S10, S4 & | C1, C2 | LB | BI1 |
| | S5, S11, S12, S8 | | | |
| CP | S1-S4 & | C1, C2 | LS | BI1 |
| | S5-S8 | | | |
| Shared | S1, S4, S5, S8 | C1, C2 | — | BI1 |
| components | | | | |

In some embodiments, it may be useful to split the BK circuitry and CP circuitry between two different IC chips. In such cases, it may be useful to add “mirror” switches S1′, S5′, S4′, and S8′ (shown connected by dotted lines) that are essentially ganged with respective switches S1, S5, S4, and S8. Accordingly, all of the switches for the BK circuitry (S1′, S9, S10, S4 & S5′, S11, S12, S8′) may be fabricated on a first IC chip, while all of the switches for the CP circuitry (S1-S4 & S5-S8) may be fabricated on a second IC chip. In general, the capacitors C1, C2 and the inductors L_{B}, L_{S} may be off-chip components, with the capacitors C1, C2 coupled to both of the BK and CP IC chips.

### Fifth Embodiment

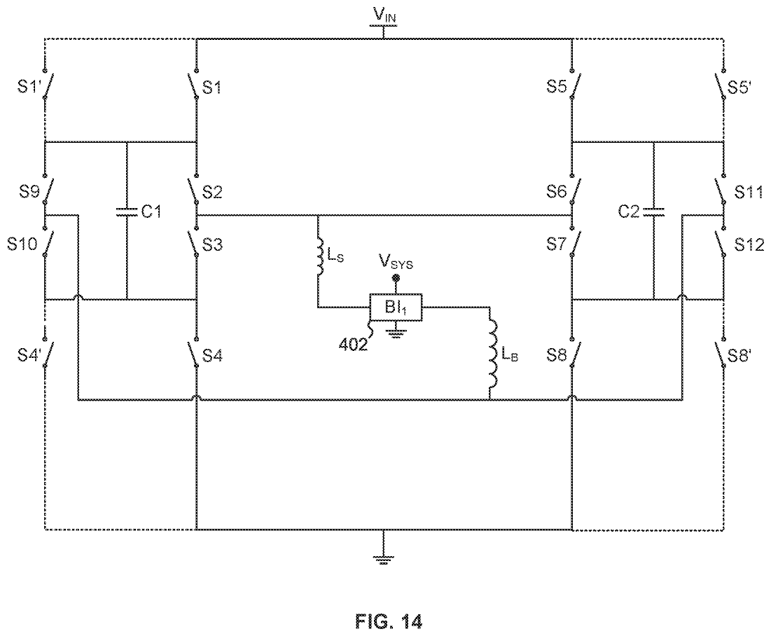

FIG. 15 is a schematic diagram of a fifth embodiment of combined charge pump and inductive buck converter circuits suitable for use in a battery management circuit. The illustrated example allows for a two-phase charge pump when in CP mode, and shared inductors when in BK mode.

Dual parallel stacks of series-coupled power switches S1-S4, S1′-S2′ are coupled between an input terminal for V_{IN} and a reference terminal. A first fly capacitor C1 is coupled in series between switches S1 and S4, a second fly capacitor C2 is coupled in series between switches S1′ and S4′. A relatively small inductor L_{S} is coupled between both switch pairs S2-S3 and S2′-S3′ and a BI₂ circuit 602. Accordingly, switches S1-S4, S1′-S4′, capacitors C1 and C2, and inductor L_{S} comprise a two-phase charge pump.

A set of series-coupled power switches S5-S8 are also coupled between the input terminal and the reference terminal, and a third fly capacitor C3 is coupled in series between switches S5 and S8. A relatively large inductor L_{B} (e.g., 2-100 times the inductance of L_{S}) is coupled between switch pairs S6-S7 and the BI₂ circuit 602. Accordingly, switches S5-S8, capacitor C3, and inductor L_{B} comprise a 3-Level buck converter.

The series coupling of the inductors L_{B} and L_{S} allows the inductor L_{B} to have a lesser inductance (by about the inductance of L_{S}) compared to embodiments in which the inductor L_{B} is coupled directly to the output terminal, and thus inductor L_{B} may be a physically smaller component than in such embodiments.

During BK operation, switches S1-S4, S1′-S4′ are opened (thus deactivating the charge pump circuitry), and switches S5-S8 are operated as described above with respect to FIG. 1B (mapping switches S5-S8 onto switches S1-S4 of FIG. 1B).

During CP operation, switches S5-S8 are opened (thus deactivating the BK circuitry), and switch sets S1-S4 and S1′-S4′ are operated in a phase interleaved manner as described above with respect to FIG. 1A.

TABLE 12 below summarizes the CP and BK circuitry configurations of the embodiment shown in FIG. 15.

TABLE 12

| | | | | BI |
|---|---|---|---|---|
| Configuration | Switches | Capacitors | Inductors | circuit |
| BK | S5-S8 | C3 | L_{B} + L_{S} | BI₂ |
| CP | S1-S4 & | C1, C2 | L_{S} | BI₂ |
| | S1′-S4′ | | | |
| Shared | — | — | L_{S} | BI₂ |
| components | | | | |

### Multi-Level Embodiments

As should be clear from the above disclosure, the various example combined charge pump and inductive buck converter circuits may be readily adapted to multi-phase charge pump circuits and/or multi-level buck converter circuits (e.g., 2-Level, 3-Level, 4-Level, etc.). In various embodiments, the phrase “combined charge pump and inductive buck converter circuits” means that a combination of CP circuitry and BK circuitry may be allocated to one, two, or more IC chips that share components (switches, capacitors, inductors) as may be useful for particular applications. Many embodiments provide a reduction in size (IC area) compared to conventional designs due to sharing of one or more components between CP and BK circuitry.

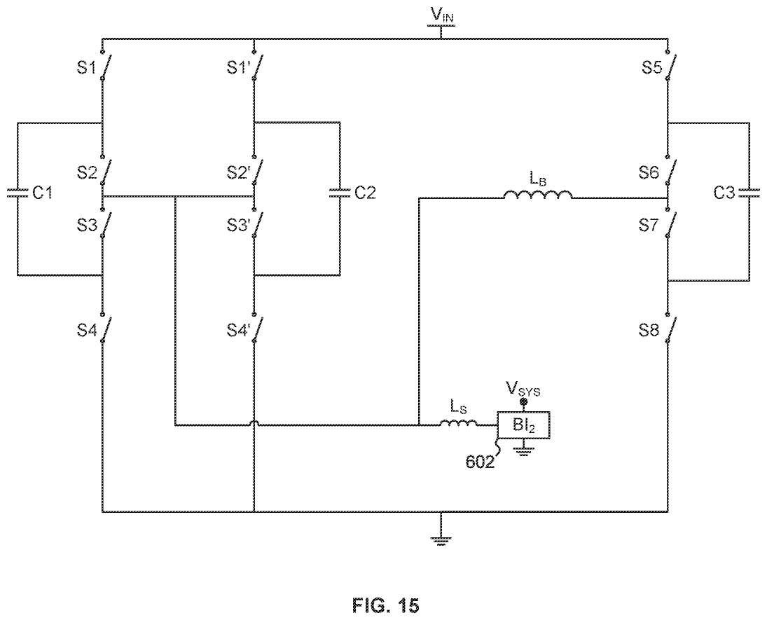

FIG. 16 is schematic diagram of a first embodiment of a multi-level, multi-phase charge pump and inductive buck converter circuit 1600 suitable for use as a battery management system. In the illustrated example, BK switch blocks 1602a and 1602b each include the switches for implementing an N-Level inductive buck converter, where N≥2. A CP switch block 1604 includes the switches for implementing an M-Level adiabatic charge pump, where M≥3; the charge pump may be single-phase or double-phase. The BK switch blocks 1602a and 1602b and the CP switch block 1604 are coupled in parallel to set of shared fly capacitors C_{F} of sufficient number to enable the N-Level inductive buck converters and the M-Level adiabatic charge pump (including shared fly capacitors C_{F} to support the selected phasing of the CP switch block 1604). As an example, N may be 5, resulting in the BK switch blocks 1602a and 1602b being configured for a 5-Level buck converter requiring 3 shared fly capacitors C_{F} each. With shared fly capacitors C_{F}, the CP switch block 1604 may be configured as a 5-Level charge pump, and hence M=5. Note that FIG. 14 is an example of FIG. 16 where N=3 and M=3.

The output of the CP switch block 1604 is coupled to a BI₁ circuit 402 through a relatively small inductor L_{S}. The joined outputs of the BK switch blocks 1602a and 1602b are coupled to a relatively large inductor L_{B} (e.g., 2-100 times the inductance of L_{S}), which in turn is coupled to the BI₁ circuit 402.

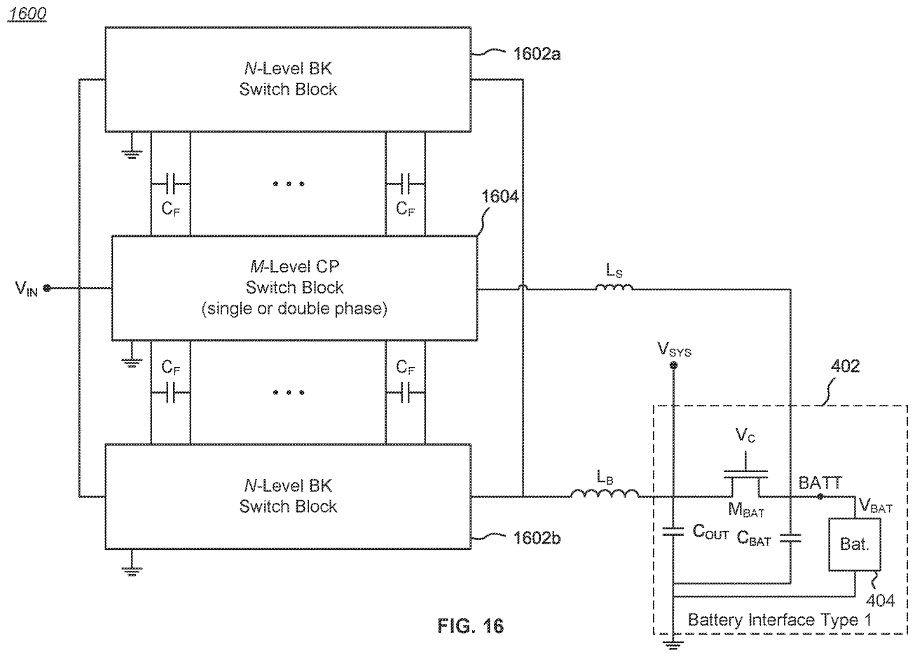

FIG. 17 is schematic diagram of a second embodiment of a multi-level, multi-phase charge pump and inductive buck converter circuit 1700 suitable for use as a battery management system. Similar in many aspects to the circuit 1600 shown in FIG. 16, the outputs of the BK switch blocks 1602a and 1602b and the CP switch block 1604 are coupled differently. In particular, the outputs of the BK switch blocks 1602a and 1602b are coupled to a relatively large inductor L_{B}, which in turn is coupled to a relatively small inductor L_{S}. The output of the CP switch block 1604 is also coupled to inductor L_{S}, which in turn is coupled to a BI₂ circuit 602. In general, transistor M_{BAT} is set to a closed (ON) state when the CP is operational.

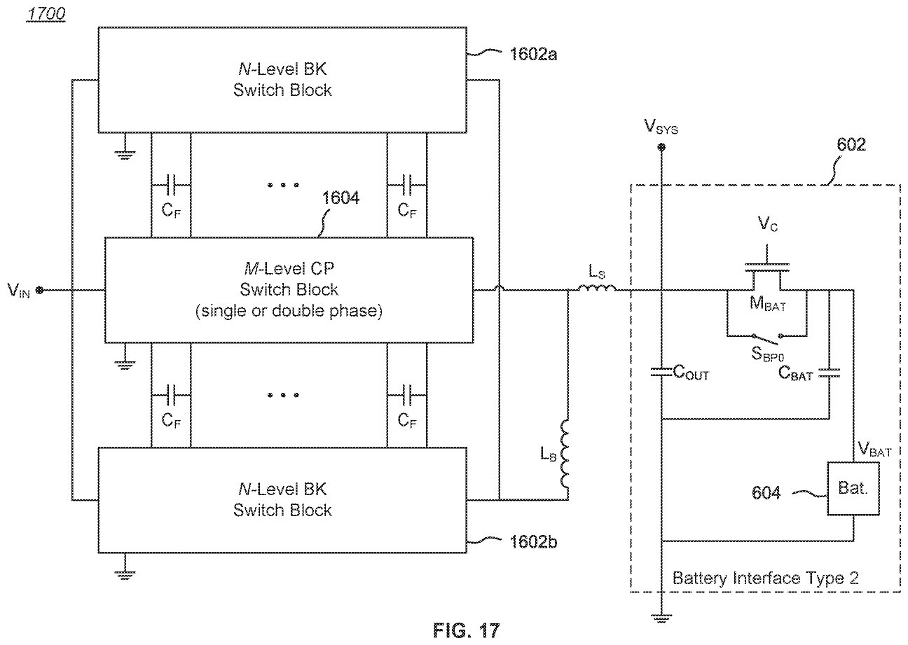

FIG. 18 is schematic diagram of a third embodiment of a multi-level, multi-phase charge pump and inductive buck converter circuit 1800 suitable for use as a battery management system. Similar in many aspects to the circuit 1600 shown in FIG. 16, the fly capacitors C_{F} and small and large inductors L_{S}, L_{B} are coupled differently. In particular, the BK switch blocks 1602a and 1602b and the CP switch block 1604 are coupled in parallel to a set of shared fly capacitors C_{F} of sufficient number to enable the N-Level inductive buck converters. The CP switch block 1604 may be coupled in parallel to the same set of shared fly capacitors C_{F} (or some subset of those fly capacitors C_{F}), as well as to some number of series-connected fly capacitors CFs that are not shared with the BK switch blocks 1602a and 1602b. In addition, the single large inductor L_{B} used in the circuit 1600 of FIG. 16 is shown as being replaced by two smaller inductors L_{B1} and L_{B2} coupled in parallel (note that the total inductance of the two inductors L_{B1} and L_{B2} is still greater than the inductance of the small inductor L_{S}). In some embodiments, the inductors L_{B1} and L_{B2} may be electromagnetically uncoupled, while in other embodiments, the inductors L_{B1} and L_{B2} may be electromagnetically coupled (as suggested by dashed line 1802). The illustrated architecture that shows that embodiments of the present invention allow great flexibility in selecting architectural details for particular applications. For example, N may be 3, resulting in the BK switch blocks 1602a and 1602b being configured for a 3-Level buck converter requiring 1 shared fly capacitor C_{F} each. With unshared fly capacitors CFs, the CP switch block 1604 may still be configured as a 5-Level charge pump, and hence M=5.

### Dickson Charge Pump Embodiments

The multi-level, multi-phase charge pump and inductive buck converter circuits shown in FIGS. 16-18 may be adapted for use with other types of charge pumps, such as Dickson charge pumps. Dickson charge pumps may be characterized by the number of voltage levels M or by a conversion factor K, generally expressed as a ratio K:1. For example, a Dickson charge pump having a 4:1 conversion ratio (K=4) is a 5-Level circuit (M=5) having 5 internal voltage levels (0 V_{IN}, ¼ V_{IN}, ½ V_{IN}, ¾ V_{IN}, and 1 V_{IN}). Combining a Dickson charge pump with a multi-level buck converter allows a synergistic sharing of fly capacitors and enables concurrent operation at times.

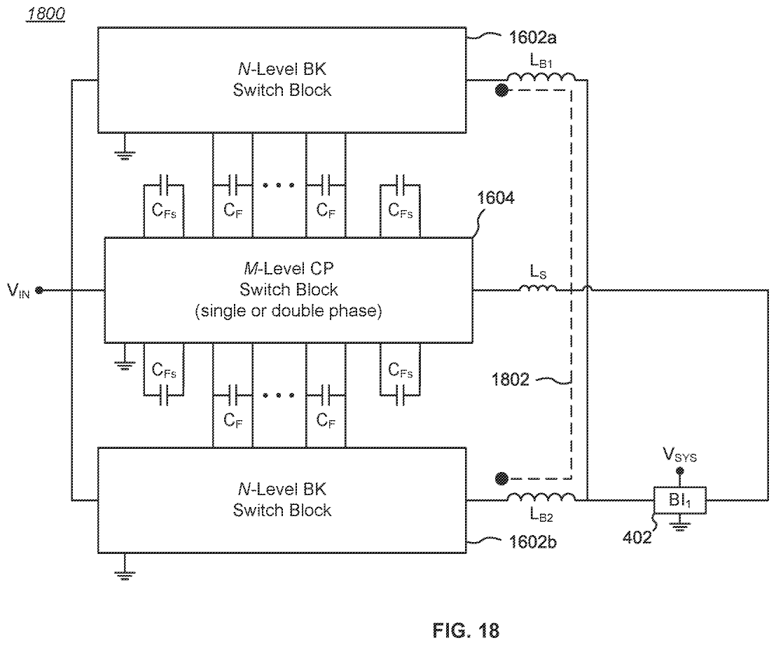

FIG. 19 is a schematic diagram of a prior art divide-by-4 (4:1) dual-phase Dickson charge pump 1900. The illustrated charge pump 1900 includes dual parallel cells 1902a, 1902b that are coupled between a voltage source V_{IN} and a reference potential such as circuit ground. Each cell 1902a, 1902b includes a set of switches (generically, Sx) and a set of fly capacitors (generically, Cx), with each switch coupled to one of two phase-interleaved clock signals, P1 or P2. Referring to cell 1902a, a subset of 4 switches S1, S2, S3, S8 are coupled in series to a first branch comprising 2 series-connected switches S4, S5, and to a second branch comprising 2 series-connected switches S6, S7. Switch S1 is also coupled to V_{IN}, and switches S5 and S7 are also coupled to the reference potential. Each switch may comprise, for example, one or more FETs, including one or more MOSFETs.

Again referring to cell 1902a, coupled between a first upper pair of alternating phase (P2, P1) switches S1, S2 and a first branch pair of alternating phase (P2, P1) switches S4, S5 is a first capacitor C1. Coupled between a second upper pair of alternating phase (P1, P2) switches S2, S3 and a second branch pair of alternating phase (P1, P2) switches S6, S7 is a second capacitor C2. Coupled between a third upper pair of alternating phase (P2, P1) switches S3, S8 and the first branch pair of alternating phase (P2, P1) switches S4, S5 is a third capacitor C3.

Cell 1902b is essentially identical (with like switches and fly capacitors denoted by a prime symbol), except that the phasing of the clock signals P1, P2 is complementary with respect to cell 1902a. Output nodes A, B of the cells 1902a, 1902b, between switches S8, S6 and S8′, S6′ respectively, are coupled at an output terminal Term Vo, which generally would be coupled to an output capacitor (e.g., C_{BAT} in FIG. 16, C_{OUT} in FIG. 17) through an inductor.

In this example, with 3 fly capacitors per cell 1902a, 1902b and an output capacitor coupled to TermVo, the Dickson charge pump 1900 divides V_{IN} to an output voltage V_{O}=¼V_{IN} at the output terminal Term Vo. The steady-state voltages across C1, C1′ would be 3V_{O}=¾V_{IN}. The steady-state voltages across C2, C2′ would be 2V_{O}=½V_{IN}. The steady-state voltages across C3, C3′ would be 1V_{O}=¼V_{IN}. The bottom of the fly capacitors will be at zero volts at certain times.

The divide-by-4 Dickson charge pump 1900 of FIG. 19 may be converted into a divide-by-3 (3:1) Dickson charge pump by removing fly capacitors C3, C3′ and switches S8, S8′. Dickson charge pumps having other division ratios are known in the art.

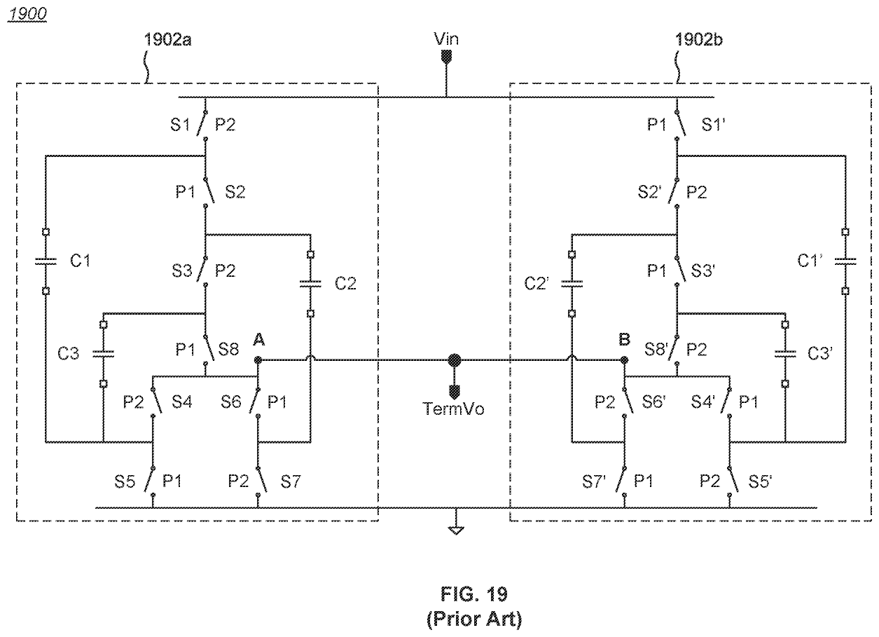

FIG. 20 is a schematic diagram of a prior art 5-Level inductive buck converter 2000. A switch block 2002 includes switches S1-S4 coupled in series between a first terminal of an inductor L_{B} and a terminal for receiving an input voltage V_{IN}. Switches S5-S8 are coupled in series between the first terminal of the inductor L_{B} and a reference voltage such as circuit ground. Fly capacitor C1 is coupled between the S1-S2 switch pair and the S5-S6 switch pair as shown. Fly capacitor C2 is coupled between the S2-S3 switch pair and the S6-S7 switch pair as shown. Fly capacitor C3 is coupled between the S3-S4 switch pair and the S7-S8 switch pair as shown. A second terminal of the inductor L_{B} is coupled to an output terminal for providing an output voltage V_{O}. An output capacitor C_{OUT} is coupled between the second terminal of the inductor L_{B} and the reference voltage. Reference may also be made to the 3-Level inductive buck converter shown in FIG. 1B.

The fly capacitors C₁-C₃ are shown within the bounds of the switch block 2002, but may be externally located with respect to the switch block 2002. Two of the 5-Level inductive buck converters 2000 may be used concurrently, with phase-interleaved switching, to form a two-phase 5-Level inductive BK. In operation, the 5-Level inductive buck converter 2000 divides V_{IN} down to any of 5 different voltages at the L_{X} node; pulse-width modulation of the switching sequences regulates the average output to a desired value at V_{O}. The steady-state average voltages across C1 would be 3V_{O}=¾V_{IN}. The steady-state average voltages across C2 would be 2V_{O}=½V_{IN}. The steady-state average voltages across C3 would be 1V_{O}=¼V_{IN}.

Thus, the fly capacitor voltages of a divide-by-4 (“4:1” or “5-Level”) dual-phase Dickson charge pump 1900 advantageously match up to the fly capacitor voltages of a two-phase 5-Level inductive buck converter, resulting in a number of synergistic benefits. TABLE 13 summarizes the steady-state average fly capacitor voltages for a single-phase Dickson charge pump and a single-phase 5-Level inductive BK.

TABLE 13
Steady-State Average Fly Capacitor Voltages

| | 4:1 Dickson charge pump | 5-Level inductive BK |
|---|---|---|
| Fly capacitor C1 | ¾ V_{IN} | ¾ V_{IN} |
| Fly capacitor C2 | ½ V_{IN} | ½ V_{IN} |
| Fly capacitor C3 | ¼ V_{IN} | ¼ V_{IN} |

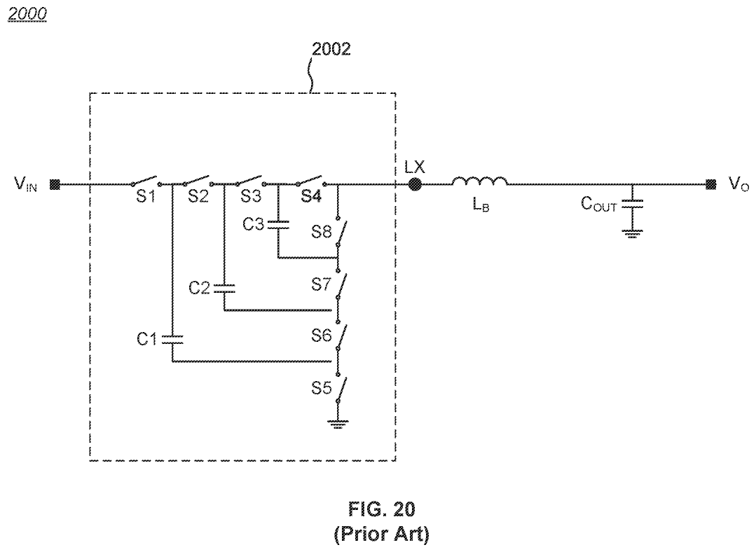

Accordingly, using the configuration shown in FIG. 16, all fly capacitors may be shared by a dual-phase Dickson charge pump and a two-phase inductive buck converter may share all fly capacitors, or by a dual-phase Dickson charge pump and a single-phase inductive buck converter, or by a single-phase Dickson charge pump and a single-phase inductive buck converter. For example, FIG. 21 is schematic diagram of a first embodiment of a charge pump and inductive buck power converter circuit 2100 based on a dual-phase 4:1 (5-Level) Dickson charge pump and a two-phase 5-Level inductive buck converter. In the illustrated example, BK switch blocks 2102a and 2102b each include the switches for implementing a 5-Level inductive buck converter, such as is shown in FIG. 20. A CP switch block 2104 includes the switches for implementing a divide-by-4 Dickson charge pump, such as is shown in FIG. 19. In the illustrated example, the Dickson charge pump is dual-phase, and thus would have two sets of fly capacitors: C1-C3 and C1′-C3′. The BK switch block 2102a and the Dickson CP switch block 2104 are coupled in parallel to first set of shared fly capacitors C1-C3, and the BK switch block 2102b and the Dickson CP switch block 2104 are coupled in parallel to a second set of shared fly capacitors C1′-C3′. The output of the Dickson CP switch block 1604 is coupled to a BI₁ circuit 402 through a relatively small inductor L_{S}. The joined outputs of the BK switch blocks 1602a and 1602b are coupled to a relatively large inductor L_{B} (e.g., 2-100 times the inductance of L_{S}), which in turn is coupled to the BI circuit 402.

The power converter circuit 2100 of FIG. 21 may operate in one mode at a time, either as a two-phase 5-Level inductive buck converter (BK switch blocks 2102a and 2102b active) or as a 4:1 dual-phase Dickson charge pump (Dickson CP switch block 2104 active). However, switching between the two modes preferably occurs when the shared fly capacitor voltages are at the common steady-state values (fly capacitor voltages may fluctuate with load). Thus, to avoid sudden changes in fly capacitor voltages, the BK switches and the Dickson CP switches may operate concurrently to assure charge balance on the shared fly capacitors, and then one or the other set of switches may be turned OFF.

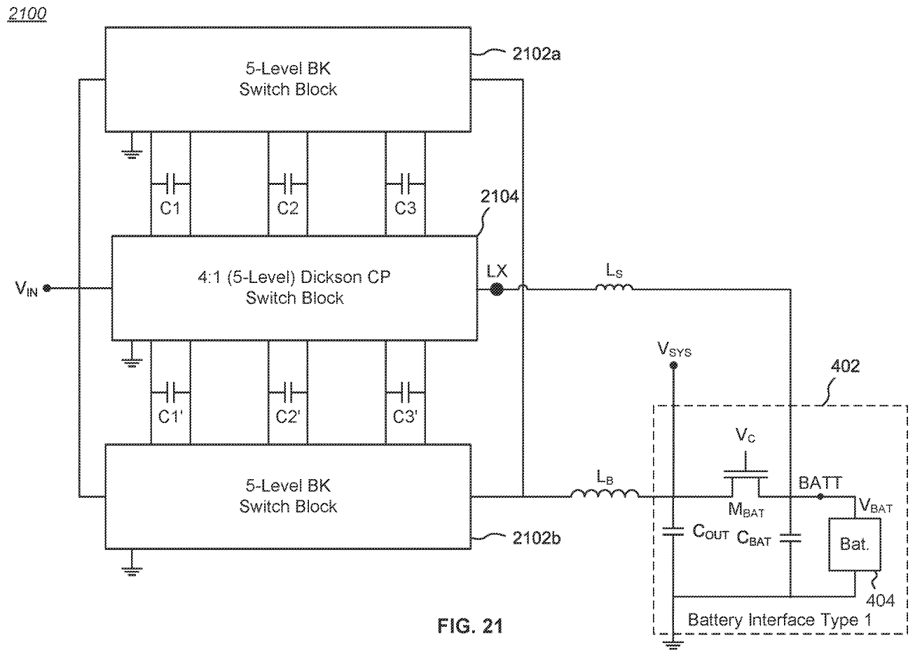

Using the configuration shown in FIG. 17, a dual-phase Dickson charge pump and a two-phase inductive buck converter may share all fly capacitors and an inductor. For example, FIG. 22 is schematic diagram of a second embodiment of a charge pump and inductive buck power converter circuit 2200 based on a dual-phase 4:1 (5-Level) Dickson charge pump and a two-phase 5-Level inductive buck converter. In the illustrated example, BK switch blocks 2202a and 2202b each include the switches for implementing a 5-Level inductive buck converter, such as is shown in FIG. 20. A CP switch block 2204 includes the switches for implementing a divide-by-4 Dickson charge pump, such as is shown in FIG. 19. In the illustrated example, the Dickson charge pump is dual-phase, and thus would have two sets of fly capacitors: C1-C3 and C1′-C3′. The BK switch block 2202a and the Dickson CP switch block 2204 are coupled in parallel to first set of shared fly capacitors C1-C3, and the BK switch block 2202b and the Dickson CP switch block 2204 are coupled in parallel to a second set of shared fly capacitors C1′-C3′. Further, the outputs of the BK switch blocks 1602a and 1602b are coupled to a relatively large inductor L_{B}, which in turn is coupled to a relatively small inductor L_{S}. The output of the Dickson CP switch block 2204 is also coupled to inductor L_{S}, which in turn is coupled to a BI₂ circuit 602. In general, transistor M_{BAT} is set to a closed (ON) state when the Dickson CP is operational.

The power converter circuit 2200 of FIG. 22 may operate in one mode at a time, either as a two-phase 5-Level inductive buck converter (BK switch blocks 2202a and 2202b active) or as a 4:1 dual-phase Dickson charge pump (Dickson CP switch block 2204 active). However, switching between the two modes preferably occurs when the shared fly capacitor voltages are at the common steady-state values (fly capacitor voltages may fluctuate with load). Thus, to avoid sudden changes in fly capacitor voltages, the BK switches and the Dickson CP switches may operate concurrently to assure charge balance on the shared fly capacitors, and then one or the other set of switches may be turned OFF.

The 5-Level BK is generally activated at the beginning and/or end of a battery charging cycle, and during non-PPS operation (e.g., zones Z1-Z3 and Z6 in FIG. 3B). The 4:1 (5-Level) Dickson CP is generally activated during the middle portion of a battery charging cycle (e.g., zones Z4-Z5 in FIG. 3B).

The architectures shown in FIGS. 21 and 22 may be scaled such that the level M of the two-phase inductive buck converter is generally one more than the conversion factor K of the dual-phase Dickson charge pump, thereby allowing all fly capacitors to be shared. Thus, N=K+1 for many of such architectures, where K≥2 (see also Table 14 below). For example, if the dual-phase Dickson charge pump is a 5:1 embodiment (thus requiring two sets of 4 fly capacitors), then a 6-Level two-phase inductive buck converter (each phase requiring 4 fly capacitors) would share two sets of four fly capacitors (i.e., 8 fly capacitors total).

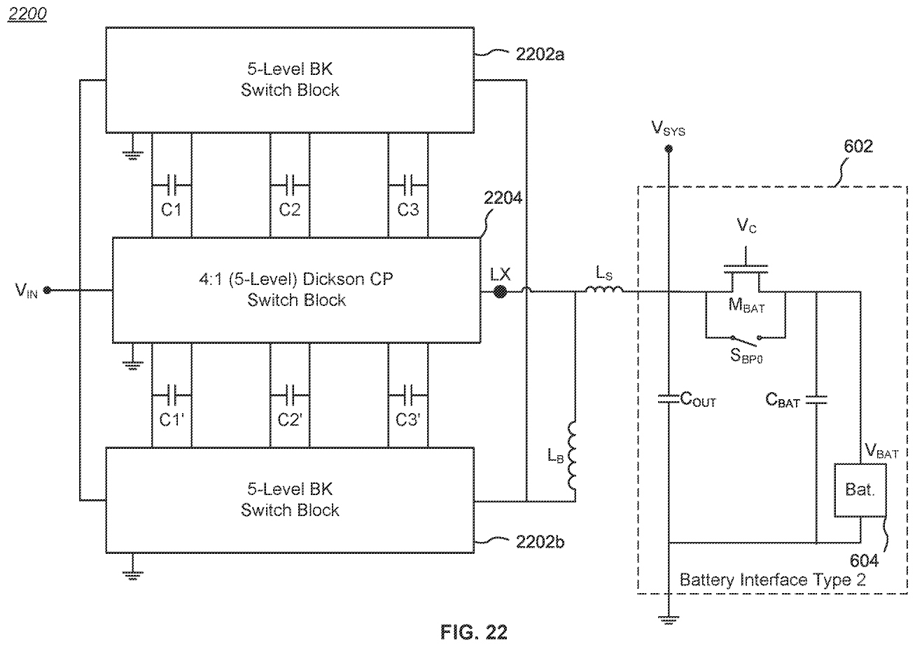

Using the configuration shown in FIG. 18, a dual-phase Dickson charge pump and a two-phase inductive buck converter may share some fly capacitors. For example, FIG. 23 is schematic diagram of an embodiment of a charge pump and inductive buck power converter circuit 2300 based on a dual-phase 4:1 (5-Level) Dickson charge pump and a two-phase 3-Level inductive buck converter. The 3-Level BK switch blocks will require one fly capacitor (see FIG. 1B). As noted above, the presence of a single fly capacitor enables four switch states that each generate one of three voltage levels at node L_{X}: 0V (GND), V_{IN}, or V_{IN}/2 (in two different ways). Thus, the steady-state voltage across the single fly capacitor is ½V_{IN}, which matches the steady-state voltage across the fly capacitor C2 of a 4:1 (5-Level) Dickson charge pump. Accordingly, one fly capacitor may be shared between one phase of a 3-Level inductive buck converter and one phase of a 4-Level Dickson charge pump.

In the example shown in FIG. 23, a pair of 3-Level BK switch blocks 2302a and 2302b and a Dickson CP switch block 2304 are coupled in parallel to shared fly capacitors C2, C2′ (each functioning as the single fly capacitor of a 3-Level BK). In addition, the Dickson CP switch block 2304 is coupled to non-shared fly capacitor pairs C1, C1′ and C3, C3′. The output of the Dickson CP switch block 2304 is coupled to a BI₁ circuit 402 through a relatively small inductor L_{S}. In this example, as in FIG. 18, the single large inductor L_{B} used in the circuit 1600 of FIG. 16 is shown as being replaced by two smaller inductors L_{B1} and L_{B2} coupled between the respective outputs of the pair of 3-Level BK switch blocks 2302a and 2302b and the BI₁ circuit 402 (note that the total inductance of the two inductors L_{B1} and L_{B2} is still greater than the inductance of the small inductor L_{S}). In some embodiments, the inductors L_{B1} and L_{B2} may be electromagnetically uncoupled, while in other embodiments, the inductors L_{B1} and L_{B2} may be electromagnetically coupled (as suggested by dashed line 2306). In alternative embodiments, a single large inductor L_{B} may be used, as in the circuit 1600 of FIG. 16. In an alternative embodiment, the outputs of the Dickson CP switch block 2304 and the pair of 3-Level BK switch blocks 2302a and 2302b may be coupled to a BI₂ circuit, as in FIG. 22.

The power converter circuit 2300 of FIG. 23 may operate in one mode at a time, either as a two-phase 3-Level inductive buck converter (BK switch blocks 2302a and 2302b active) or as a 4:1 dual-phase Dickson charge pump (Dickson CP switch block 2304 active). However, switching between the two modes preferably occurs when the shared fly capacitor voltages are at the common steady-state values (fly capacitor voltages may fluctuate with load). Thus, to avoid sudden changes in fly capacitor voltages, the BK switches and the Dickson CP switches may operate concurrently to assure charge balance on the shared fly capacitors, and then one or the other set of switches may be turned OFF.

The architecture shown in FIG. 23 may be scaled so that a complete set or a proper subset of fly capacitors having matching steady-state voltages are shared between N-Level inductive buck converters and K:1 Dickson charge pumps so long as N bears a specific relationship to K. For example, TABLE 14 shows example sets of non-zero voltages associated with different N-Level buck converters and K:1 Dickson charge pumps. Extensions of the patterns of voltages associated with N and K can be derived, since the fractional voltages for any integer value of K have K as a denominator and integer numerators from 1 to K−1.

TABLE 14

| N | K Factor | Sets of Voltages |
|---|---|---|
| Level | (K:1) | (fractions of V_{IN}) |
| 3 | 2 | ½ |
| 4 | 3 | ⅓, ⅔ |
| 5 | 4 | ¼, 2/4, ¾ |
| 6 | 5 | ⅕, ⅖, ⅗, ⅘, |
| 7 | 6 | ⅙, 2/6, 3/6, 4/6, ⅚ |

As should be clear, a complete set of fly capacitors may be shared between an N-Level buck converter and a K:1 Dickson charge pump when associated sets of voltages are shared—that is, when N=K+1, where K≥2.

Moreover, a subset of fly capacitors may be shared between an N-Level inductive buck converter and a K:1 Dickson charge pump when some values in the associated sets of voltages are shared. For example, in Table 14, the values equal to ½ (½, 2/4, 3/6) are bolded to indicate that corresponding N-Level inductive buck converters and K:1 Dickson charge pumps may share at least one fly capacitor. Thus, for example, a 3-Level inductive buck converter may share fly capacitors with 2:1, 4:1, and 6:1 Dickson charge pumps. Similarly, a 2:1 Dickson charge pump may share fly capacitors with 3-Level, 5-Level, and 7-Level inductive buck converters.

TABLE 15 shows further examples of N-Level inductive buck converters which may share at least one fly capacitor with one or more K:1 Dickson charge pumps.

TABLE 15

| N Level | K Factors with Shared Fly Capacitors |
|---|---|
| 3 | 2:1, 4:1, 6:1 . . . |
| 4 | 3:1, 6:1, 9:1 . . . |
| 5 | 4:1, 8:1, 12:1 |

More generally, any N-Level inductive buck converter may share fly capacitors with any K:1 Dickson charge pump where K is a positive integer multiple of N−1: K=i(N−1), where i≥1. For example, for N=6, possible Dickson charge pump conversion factors are 5:1, 10:1, 15:1, etc.

TABLE 16 shows further examples of K:1 Dickson charge pumps which may share at least one fly capacitor with one or more N-Level inductive buck converters.

TABLE 16

| K Factor | N Levels with Shared Fly Capacitors |
|---|---|
| 2 | 3L, 5L, 7L . . . |
| 3 | 4L, 7L, 10L . . . |
| 4 | 5L, 9L, 13L . . . |

More generally, any K:1 Dickson charge pump may share fly capacitors with any N-Level inductive buck converter where Nis one more than a positive integer multiple of N:N=iK+1, where i≥1. For example, for K=5, possible values of N are 6L, 11L, 16L, etc.

Conventional charge pumps output charge directly to an output capacitor C_{OUT}, without passing current through an inductor L_{S}. Stated differently, a charge pump that provides charge through an inductor L_{S} to an output capacitor C_{OUT} forms a hybrid power converter. As a consequence of the presence of the inductor L_{S}, such a charge pump (including a Dickson charge pump) has a different voltage and current waveform at a node L_{X} (see FIGS. 21-23) looking into the inductor L_{S} relative to conventional switch mode power supplies.

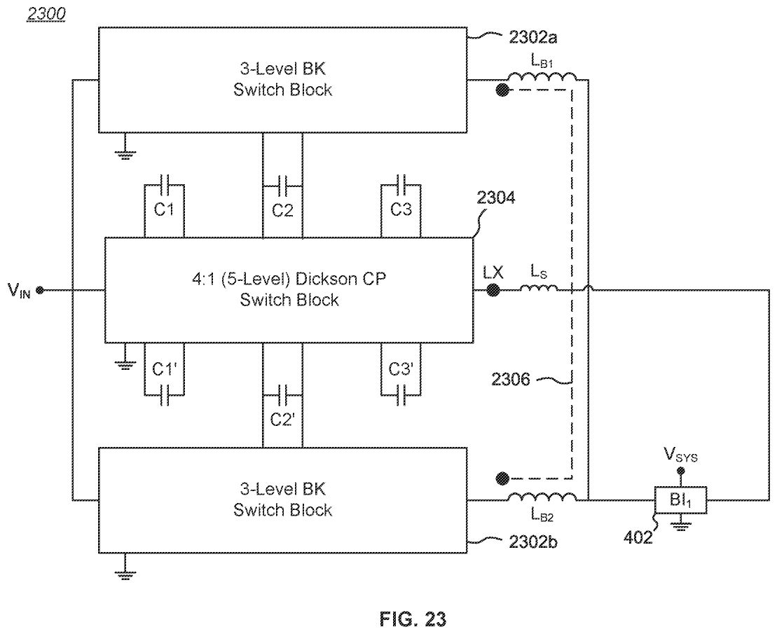

For example, FIG. 24 shows a set of example graphs 2400 of output voltage and current as a function of time for a conventional switch mode power supply. While the voltage is essentially a square wave, the current has a triangular waveform.

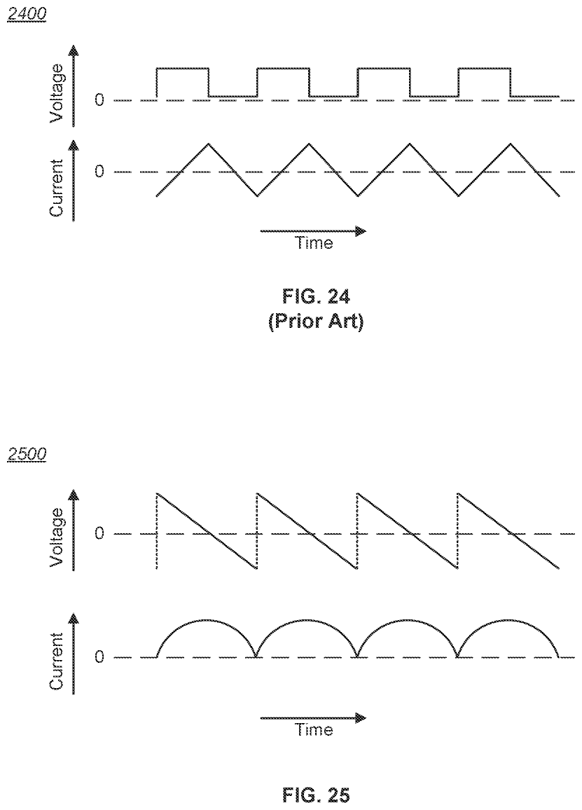

In contrast, FIG. 25 shows a set of example graphs 2500 of output voltage and current as a function of time for a charge pump that provides charge through an inductor L_{S} to an output capacitor C_{OUT}. The voltage periodically suddenly rises (shown by dotted lines) to a maximum value, then linearly declines to a minimum value before repeating. Because of the presence of the inductor L_{S}, the corresponding current exhibits a “humped” waveform resembling a rectified sinusoidal wave.

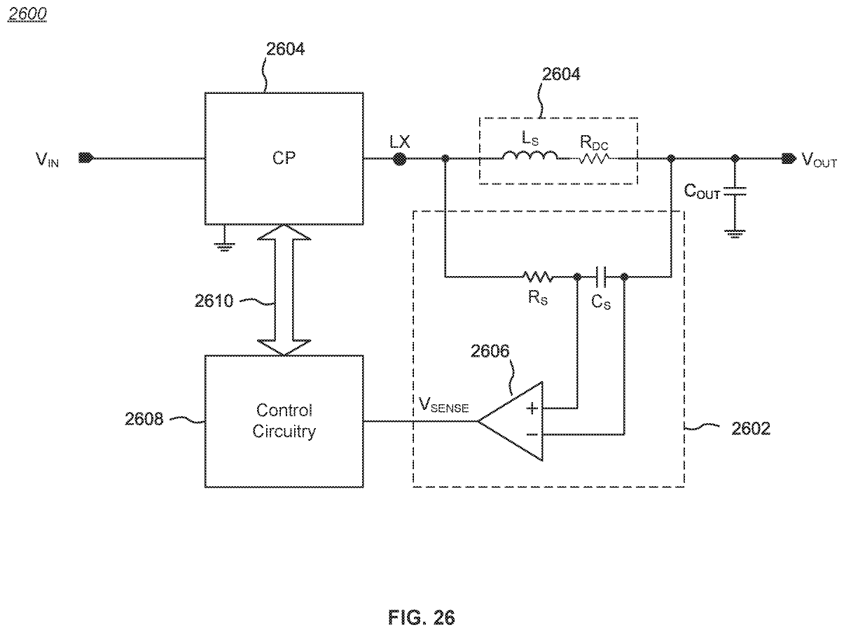

In some embodiments, it may be useful to measure the current passing through the output inductor L_{S} of a charge pump. FIG. 26 is a block diagram of a charge pump system 2600 that includes an output current sensing circuit 2602. The output of a charge pump 2604 is coupled through a node L_{X} through an inductor 2604 to an output capacitor C_{OUT}. The current sensing circuit 2602 utilizes the principal of inductor DC resistance (DCR) current sensing, which uses the inherent parasitic resistance of the inductor winding to measure current. In the illustrated example, the inductor 2604 is depicted as an equivalent series resistance R_{DC} coupled in series with an inductor winding L_{S}.

The current sensing circuit 2602 includes an RC (resistor-capacitor) circuit coupled in parallel with the inductor 2604, and hence in parallel with the parasitic resistor R_{DC}. The RC circuit of the current sensing circuit 2602 includes a sense resistor R_{S} coupled in series with a sense capacitor C_{S}. The voltage across the capacitor C_{S} is measured by a comparator 2606 (e.g., an op-amp) having a first terminal coupled to a first plate of the sense capacitor C_{S} and a second terminal coupled to a second plate of the sense capacitor C_{S}. The output V_{SENSE} of the comparator 2606 may be coupled to control circuitry 2608, which may be implemented as part of the controller 222 shown in FIGS. 2A and 2B.

With proper component selection (e.g., R_{S}*C_{S}=L_{S}/R_{DC}), the voltage measured across the capacitor C_{S} as represented by V_{SENSE} should be proportional to the current through the inductor winding L_{S}. It is preferable to select a time constant for R_{S} and C_{S} to match the time constant of L_{S}/R_{DC} (although the individual components R_{S} and R_{DC} do not have to match and C_{S} and L_{S} do not have to match). Equal time constants provide the correct instantaneous voltage representative of the current through the inductor L_{S}. However, a slower time constant (e.g., R_{S} and C_{S} larger than L_{S}/R_{DC}) provides a filtered voltage of the current through the inductor L_{S}. In some applications where high accuracy is required, the temperature coefficient of R_{S} and R_{DC} may be selected so their actual values track together with temperature.

The output V_{SENSE} of the comparator 2606 may be used, for example, in determining and setting the frequency of operation of the charge pump 2604 through connecting control signal lines 2610. Other uses of V_{SENSE} may include output current sensing for fault protection and for providing a general telemetry capability for the charge pump 2604.

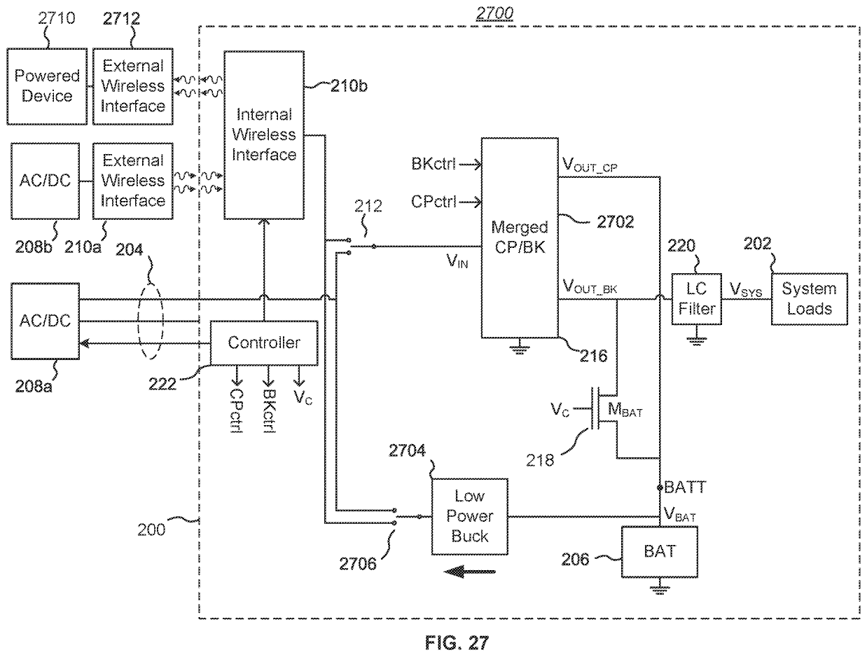

Some embodiments optionally may include a parallel low-power buck converter 224 to use for reverse power flow in low power operation. For example, FIG. 27 is a block diagram illustrating an example battery management system 2700. The battery management system 2700 is similar in most aspects to the battery management system 200 illustrated in FIG. 2, but includes a merged charge pump and inductive buck converter 2702 in accordance with the teachings of the present invention. The battery management system 2700 also includes an optional low-power reverse direction buck converter 2702 connected to the battery 206 and configured to selectively provide power from the battery 206 through a switch 2706 to the internal wireless interface 210b. The wireless interface 210b may be configured to operate in a reverse direction, for example, to power or charge a magnetically-coupled device 2710 (e.g., a headphone, battery case, cell phone, etc.) connected to an instance of an external wireless interface 2712 (e.g., a magnetic coil). In an alternative embodiment, the merged charge pump and inductive buck converter 2702 may be configured like the second example battery management system 200′ illustrated in FIG. 2B.

### Circuit Embodiments

It should be noted that while the above description and examples have focused on adiabatic charge pumps, sharing of components (e.g., switches and/or fly capacitors) may be utilized in conjunction with non-adiabatic charge pumps lacking an output inductor. Accordingly, use of an output inductor for the example charge pumps may be needed only if adiabatic operation is desired.

In some applications, certain of the power switches of a combined charge pump and inductive buck converter circuit (for example, switches S1-S2 and S5-S6 in the circuit of FIG. 4A) may function as load switches. Typically, a USB protocol may call for utilization of a load switch, which is a switch that breaks the connection between the input voltage V_{IN} and the rest of a battery management system. In some instances, a load switch may be implemented as a bidirectional switch, for example, so that it may be capable of stopping power in the forward and/or reverse direction. A typical MOSFET may have a body diode in parallel with it. So, in order to prevent that body diode from conducting, it may be useful to put two switches connected in series with the body diode of the switches pointing at each other or away from each other (i.e., opposite directions).

It should be understood that other types of battery interface circuits may be used in conjunction with embodiments of the present invention, and accordingly the invention is not limited to the battery interface circuits shown in FIGS. 21 and 22.

Circuits and devices in accordance with the present invention may be used alone or in combination with other components, circuits, and devices. Embodiments of the present invention may be fabricated as integrated circuits (ICs), which may be encased in IC packages and/or in modules for ease of handling, manufacture, and/or improved performance. In particular, IC embodiments of this invention are often used in modules in which one or more of such ICs are combined with other circuit components or blocks (e.g., filters, amplifiers, passive components, and possibly additional ICs) into one package. The ICs and/or modules are then typically combined with other components, often on a printed circuit board, to form part of an end-product such as a cellular telephone, laptop computer, or electronic tablet, or to form a higher-level module which may be used in a wide variety of products, such as vehicles, test equipment, medical devices, etc. Through various configurations of modules and assemblies, such ICs typically enable a mode of communication, often wireless communication.

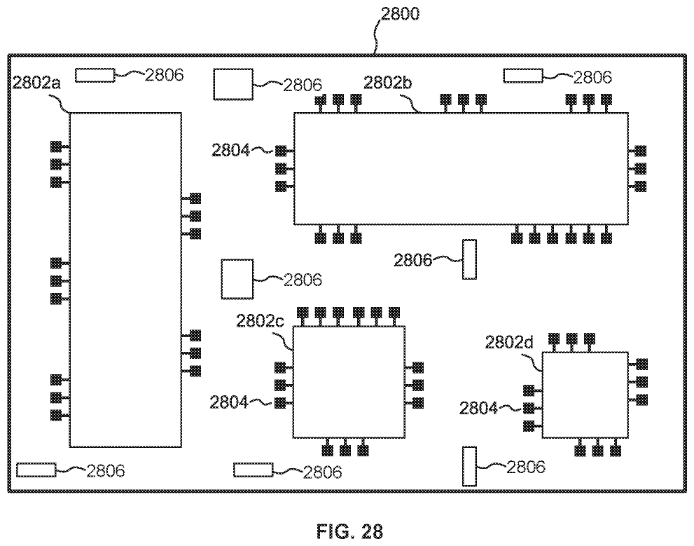

As one example of further integration of embodiments of the present invention with other components, FIG. 28 is a top plan view of a substrate 2800 that may be, for example, a printed circuit board or chip module substrate (e.g., a thin-film tile). In the illustrated example, the substrate 2800 includes multiple ICs 2802a-2802d having terminal pads 2804 which would be interconnected by conductive vias and/or traces on and/or within the substrate 2800 or on the opposite (back) surface of the substrate 2800 (to avoid clutter, the surface conductive traces are not shown and not all terminal pads are labelled). The ICs 2802a-2802d may embody, for example, signal switches, active and/or passive filters, amplifiers (including one or more LNAs), and other circuitry. For example, IC 2802b may incorporate one or more instances of a circuit like the circuits shown in FIGS. 4A, 5, 6A, 7-18, 21-23, and/or 26.

The substrate 2800 may also include one or more passive devices 2806 embedded in, formed on, and/or affixed to the substrate 2800. While shown as generic rectangles, the passive devices 2806 may be, for example, filters, capacitors, inductors, transmission lines, resistors, planar antennae elements, transducers (including, for example, MEMS-based transducers, such as accelerometers, gyroscopes, microphones, pressure sensors, etc.), batteries, etc., interconnected by conductive traces on or in the substrate 2800 to other passive devices 2806 and/or the individual ICs 2802a-2802d. The front or back surface of the substrate 2800 may be used as a location for the formation of other structures.

### Methods

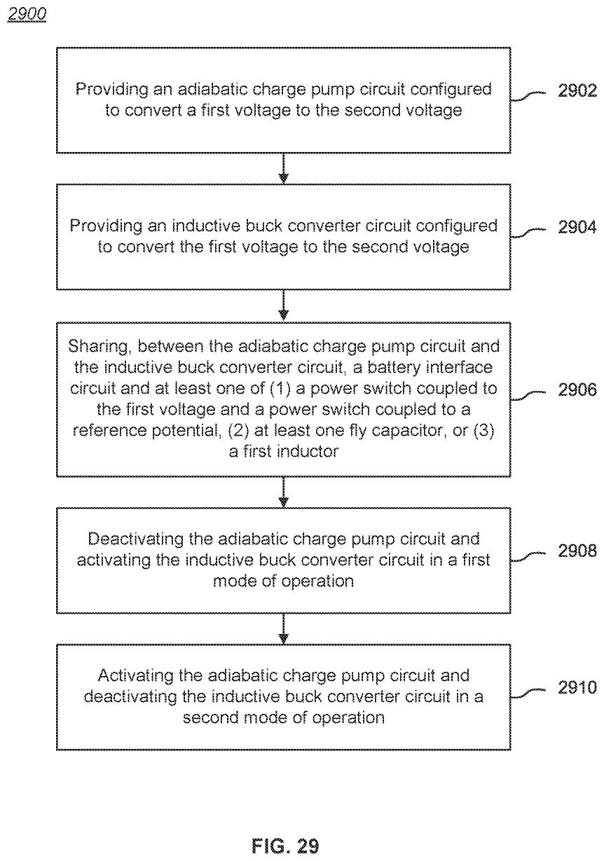

Another aspect of the invention includes methods for converting voltages. For example, FIG. 29 is a process flow chart 2900 showing one method for converting a first voltage to a second voltage. The method includes: providing an adiabatic charge pump circuit configured to convert the first voltage to the second voltage (Block 2902); providing an inductive buck converter circuit configured to convert the first voltage to the second voltage (Block 2904); sharing between the adiabatic charge pump circuit and the inductive buck converter circuit a battery interface circuit and at least one of (1) a power switch coupled to the first voltage and a power switch coupled to a reference potential, (2) at least one fly capacitor, or (3) a first inductor (Block 2906); deactivating the adiabatic charge pump circuit and activating the inductive buck converter circuit in a first mode of operation (Block 2908); and activating the adiabatic charge pump circuit and deactivating the inductive buck converter circuit in a second mode of operation (Block 2910).

### System Aspects

Embodiments of the present invention are useful in a wide variety of larger radio frequency (RF) circuits and systems for performing a range of functions, including (but not limited to) impedance matching circuits, RF power amplifiers, RF low-noise amplifiers (LNAs), phase shifters, attenuators, antenna beam-steering systems, charge pump devices, RF switches, etc. Such functions are useful in a variety of applications, such as radar systems (including phased array and automotive radar systems), radio systems (including cellular radio systems), and test equipment.

Radio system usage includes wireless RF systems (including base stations, relay stations, and hand-held transceivers) that use various technologies and protocols, including various types of orthogonal frequency-division multiplexing (“OFDM”), quadrature amplitude modulation (“QAM”), Code-Division Multiple Access (“CDMA”), Time-Division Multiple Access (“TDMA”), Wide Band Code Division Multiple Access (“W-CDMA”), Global System for Mobile Communications (“GSM”), Long Term Evolution (“LTE”), 5G New Radio, 6G, and WiFi (e.g., 802.11a, b, g, ac, ax, be) protocols, as well as other radio communication standards and protocols.

As discussed above, the current invention improves efficiency, and in many embodiments reduces IC chip area by sharing components between adiabatic charge pump circuitry and inductive buck converter circuitry. As a person of ordinary skill in the art will understand, a system architecture is beneficially impacted by the current invention in critical ways, including smaller size, lower power, and longer battery life.

### Fabrication Technologies & Options

The term “MOSFET”, as used in this disclosure, includes any field effect transistor (FET) having an insulated gate whose voltage determines the conductivity of the transistor, and encompasses insulated gates having a metal or metal-like, insulator, and/or semiconductor structure. The terms “metal” or “metal-like” include at least one electrically conductive material (such as aluminum, copper, or other metal, or highly doped polysilicon, graphene, or other electrical conductor), “insulator” includes at least one insulating material (such as silicon oxide or other dielectric material), and “semiconductor” includes at least one semiconductor material.

As used in this disclosure, the term “radio frequency” (RF) refers to a rate of oscillation in the range of about 3 kHz to about 300 GHz. This term also includes the frequencies used in wireless communication systems. An RF frequency may be the frequency of an electromagnetic wave or of an alternating voltage or current in a circuit.

Various embodiments of the invention can be implemented to meet a wide variety of specifications. Unless otherwise noted above, selection of suitable component values is a matter of design choice. Various embodiments of the invention may be implemented in any suitable integrated circuit (IC) technology (including but not limited to MOSFET structures), or in hybrid or discrete circuit forms. Integrated circuit embodiments may be fabricated using any suitable substrates and processes, including but not limited to standard bulk silicon, high-resistivity bulk CMOS, silicon-on-insulator (SOI), and silicon-on-sapphire (SOS). Unless otherwise noted above, embodiments of the invention may be implemented in other transistor technologies, such as bipolar junction transistors (BJTs), BiCMOS, LDMOS, BCD, GaAs HBT, GaN HEMT, GaAs pHEMT, MESFET, InP HBT, InP HEMT, FinFET, GAAFET, and SiC-based power device technologies, using 2-D, 2.5-D, and 3-D structures. However, embodiments of the invention are particularly useful when fabricated using an SOI or SOS based process, or when fabricated with processes having similar characteristics. Fabrication in CMOS using SOI or SOS processes enables circuits with low power consumption, the ability to withstand high power signals during operation due to FET stacking, good linearity, and high frequency operation (i.e., radio frequencies up to and exceeding 300 GHz). Monolithic IC implementation is particularly useful since parasitic capacitances generally can be kept low (or at a minimum, kept uniform across all units, permitting them to be compensated) by careful design.

Voltage levels may be adjusted, and/or voltage and/or logic signal polarities reversed, depending on a particular specification and/or implementing technology (e.g., NMOS, PMOS, or CMOS, and enhancement mode or depletion mode transistor devices). Component voltage, current, and power handling capabilities may be adapted as needed, for example, by adjusting device sizes, serially “stacking” components (particularly FETs) to withstand greater voltages, and/or using multiple components in parallel to handle greater currents. Additional circuit components may be added to enhance the capabilities of the disclosed circuits and/or to provide additional functionality without significantly altering the functionality of the disclosed circuits.

### CONCLUSION

A number of embodiments of the invention have been described. It is to be understood that various modifications may be made without departing from the spirit and scope of the invention. For example, some of the steps described above may be order independent, and thus can be performed in an order different from that described. Further, some of the steps described above may be optional. Various activities described with respect to the methods identified above can be executed in repetitive, serial, and/or parallel fashion.

It is to be understood that the foregoing description is intended to illustrate and not to limit the scope of the invention, which is defined by the scope of the following claims, and that other embodiments are within the scope of the claims. In particular, the scope of the invention includes any and all feasible combinations of one or more of the processes, machines, manufactures, or compositions of matter set forth in the claims below. (Note that the parenthetical labels for claim elements are for ease of referring to such elements, and do not in themselves indicate a particular required ordering or enumeration of elements; further, such labels may be reused in dependent claims as references to additional elements without being regarded as starting a conflicting labeling sequence).

1. A power converter circuit including:
(a) a first terminal for receiving a first voltage;
(b) a second terminal for providing a second voltage;
(c) a third terminal configured to be coupled to a reference potential;
(d) a battery interface circuit coupled to the second terminal and configured to be coupled to the reference potential;
(e) an adiabatic charge pump circuit coupled between the first terminal and the reference potential, and coupled to the battery interface circuit through a first inductor; and
(f) an inductive buck converter circuit coupled between the first terminal and the reference potential, and coupled to the battery interface circuit through a second inductor;
wherein in a first mode of operation of the power converter circuit, the adiabatic charge pump circuit is deactivated, and the inductive buck converter circuit is activated;
wherein in a second mode of operation of the power converter circuit, the adiabatic charge pump circuit is activated, and the inductive buck converter circuit is deactivated; and
wherein the adiabatic charge pump circuit and the inductive buck converter circuit share the battery interface circuit and at least one of (1) a power switch coupled to the first terminal and a power switch coupled to the third terminal, (2) at least one fly capacitor, or (3) the first inductor.

2.-55. (canceled)
